(19) United States
(12) Patent Application Publication
(10) Pub. No.: US 2026/0040298 A1
(43) Pub. Date: Feb. 5, 2026

(54) NEW RADIO (NR) EXTENDED REALITY (XR) – METHODS FOR ENSURING ROUND TRIP TIME LATENCY FOR XR TRAFFIC

(71) Applicant: INTERDIGITAL PATENT HOLDINGS, INC., Wilmington, DE (US)

(72) Inventors: Jaya Rao, Montreal (CA); Michael Starsinic, Newtown, PA (US); Xavier De Foy, Kirkland (CA); Patrice Hirtzlin, Betton (FR); Stephane Onno, Saint Gregoire (FR); Loic Fontaine, Noyal-sur-Vilaine (FR); Tejaswinee Lutchoomun, Montreal (CA)

(73) Assignee: INTERDIGITAL PATENT HOLDINGS, INC., Wilmington, DE (US)

(21) Appl. No.: 19/100,633

(22) PCT Filed: Aug. 8, 2023
(86) PCT No.: PCT/US2023/029723

§ 371 Date: Feb. 3, 2025

Related U.S. Application Data
(60) Provisional application No. 63/396,016, filed on Aug. 8, 2022.

(51) Int. Cl. H04W 72/11; H04W 72/21

(52) U.S. Cl. CPC H04W 72/11; H04W 72/21

(57) ABSTRACT

A method performed by a wireless transmit/receive unit (WTRU) may comprise: receiving, from a base station, configuration information; receiving, from an application layer, one or more uplink protocol data units (PDUs); determining a buffering delay for transmitting the one or more uplink PDUs in resources associated with configured grant (CG) physical uplink shared channel (PUSCH) occasions; and on a condition that the buffering delay is greater than a delay threshold and that there are no available resources associated with semi-persistent scheduling (SPS) physical downlink shared channel (PDSCH)occasions within a time window, transmitting an indication of a time offset for the time window. The method may further comprise transmitting, to the base station, in a CG PUSCH occasion, the one or more uplink PDUs.

### CROSS-REFERENCE TO RELATED APPLICATIONS

This application claims the benefit of U.S. Provisional Patent Application No. 63/396,016, filed Aug. 8, 2022, the contents of which are incorporated herein by reference.

### BACKGROUND

Extended reality (XR) may refer to various types of immersive experiences including, but not limited to: virtual reality (VR), augmented reality (AR), mixed reality (MR), and the realities interpolated among them. VR is a rendered version of a delivered visual and audio scene. The rendering is designed to mimic the visual (e.g., stereoscopic 3D) and audio sensory stimuli of the real world as naturally as possible to an observer or user as they move within the limits defined by the application. In AR, a user is provided with additional information or artificially generated items or content overlaid upon their current environment. MR is an advanced form of AR, where some virtual elements may be inserted into the physical scene with the intent to provide the illusion that these elements are part of the real scene. XR may include all real-and-virtual combined environments and human-machine interactions generated by computer technology and wearables.

In the context of XR applications and services, immersion may refer to the sense of being surrounded by a virtual environment as well as providing the feeling of being physically and spatially located in the virtual environment. The levels of virtuality may range from partial sensory inputs to fully immersive multi-sensory inputs leading to a virtual reality practically indiscernible from actual reality.

XR devices may be typically associated with capabilities that offer various degrees of spatial tracking. XR devices may be equipped with various sensors to enable spatial tracking, such as, monocular/stereo/depth cameras, radio beacons, GPS, and inertial sensors. Spatial tracking may be performed at different levels ((e.g., 3 Degrees of Freedom (DoF) (i.e. rotational motion along X, Y and Z axis), 6 DoF (i.e., rotational and/or translational motion along X, Y and Z axis)). Spatial tracking may result in an interaction to experience some form of virtual content. The user may act in and/or interact with the components within the extended reality. For example, the actions and/or interactions may involve movements, gestures, and/or eye tracking. Spatial tracking is an important enabler for immersive XR experience. For example, some form of head and/or motion tracking may ensure that the simulated visual and audio components from the user perspective are updated to be consistent with user's movements. Imprecise and/or delayed spatial tracking may lead to sensation of discomfort and/or motion sickness for the user.

### SUMMARY

A method performed by a wireless transmit/receive unit (WTRU) may comprise: receiving, from a base station, configuration information; receiving, from an application layer, one or more uplink protocol data units (PDUs); determining a buffering delay for transmitting the one or more uplink PDUs in resources associated with configured grant (CG) physical uplink shared channel (PUSCH) occasions; and on a condition that the buffering delay is greater than a delay threshold and that there are no available resources associated with semi-persistent scheduling (SPS) physical downlink shared channel (PDSCH) occasions within a time window, transmitting an indication of a time offset for the time window. The method may further comprise transmitting, to the base station, in a CG PUSCH occasion, the one or more uplink PDUs.

The configuration information may include at least one of a time offset associated with a start of the time window. The configuration information may include the delay threshold. The configuration information may include one or more start offsets associated with the time window. The configuration information includes a CG configuration and a SPS configuration. A CG PUSCH occasion in the CG configuration may be time-aligned in the time window. A SPS PDSCH occasion in the SPS configuration may be time-aligned in the time window. The time window may be a round trip time (RTT) window. The indication may be transmitted in an uplink control information (UCI).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example of interactive and split rendering scenarios;

FIG. 3 is a diagram illustrating an example of a WTRU determining the alignment between UL resource configuration and DL resource configuration for meeting RTT latency; and

FIG. 4 is a diagram illustrating an example of a WTRU determining the timing for DL reception to compensate for higher than expected delay during PDU arrival for UL transmission; and

FIG. 5 is a flowchart illustrating an exemplary procedure performed by a WTRU.

### DETAILED DESCRIPTION

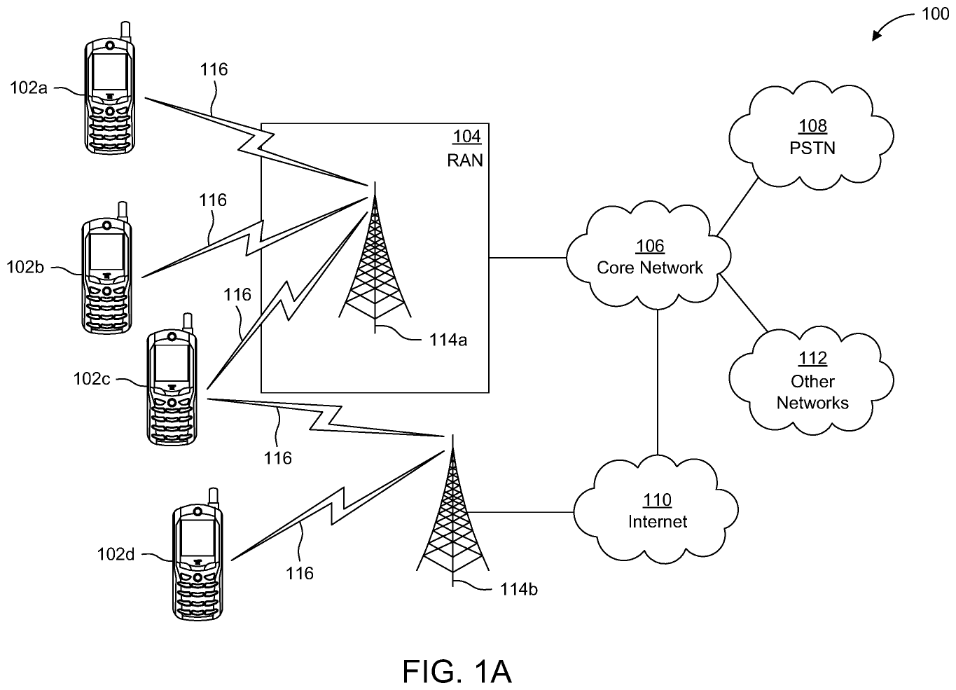

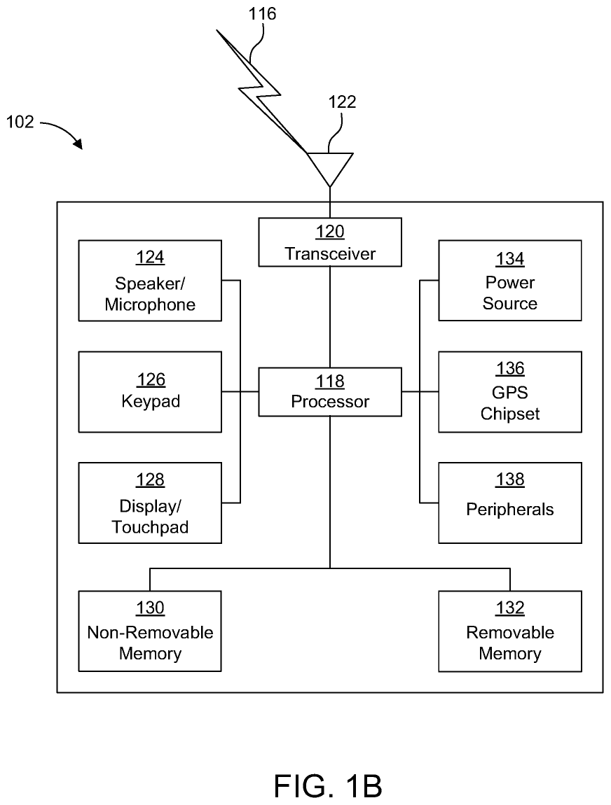

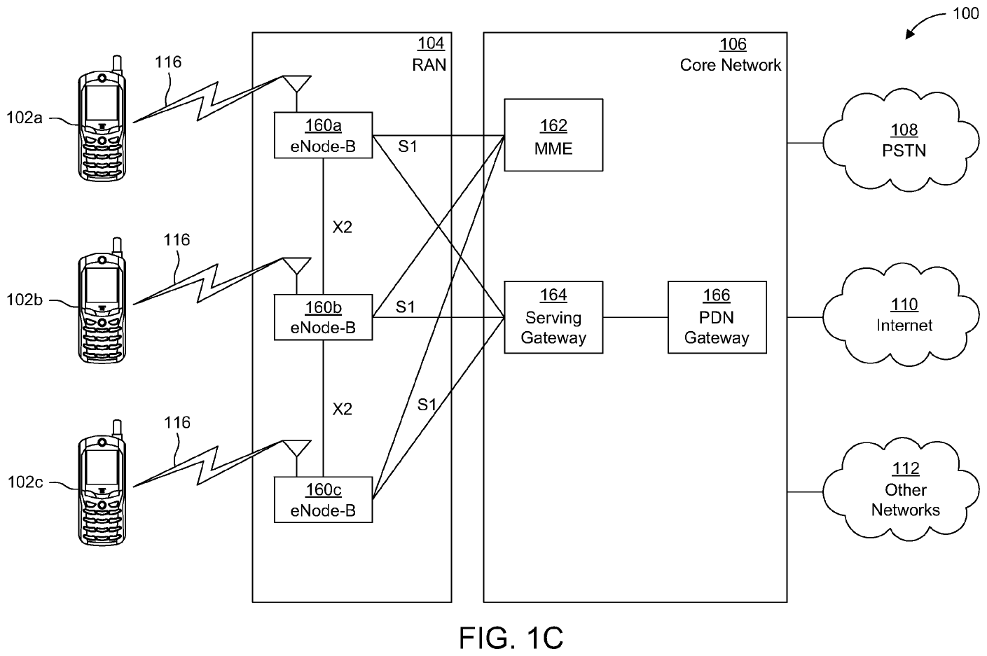

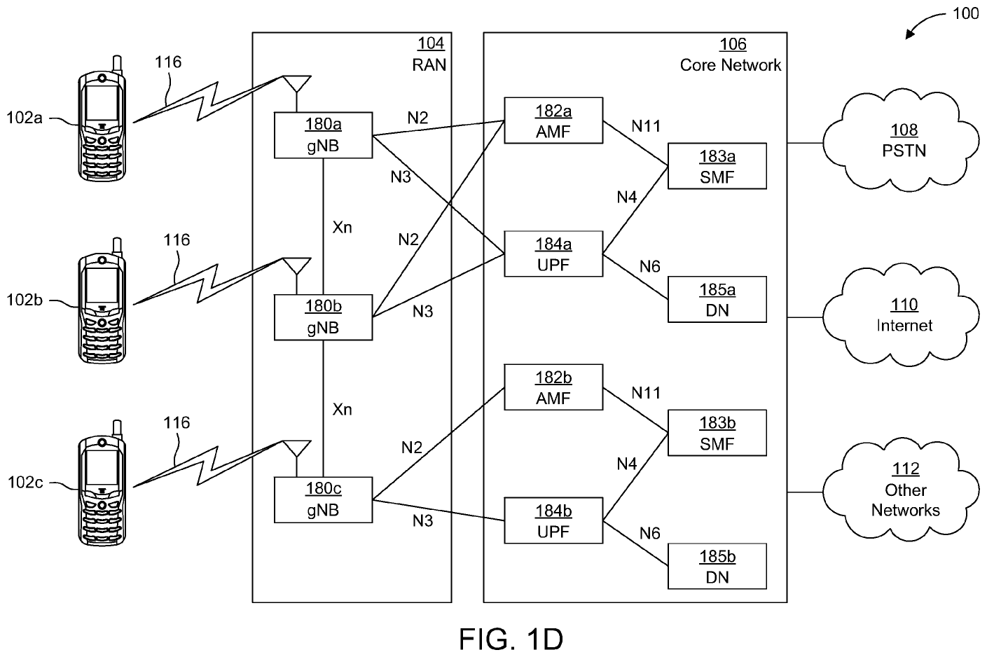

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g.,, remote surgery), an industrial device and applications (e.g.,, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g.,, radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g.,, an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g.,, for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g.,, WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g.,, the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g.,, the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g.,, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g.,, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g.,, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g.,, longitude and latitude) regarding the current location of the WTRU 102. In addition to, or in lieu of, the information from the GPS chipset 136, the WTRU 102 may receive location information over the air interface 116 from a base station (e.g.,, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g.,, associated with particular subframes for both the UL (e.g.,, for transmission) and DL (e.g.,, for reception) may be concurrent and/or simultaneous. The full duplex radio may include an interference management unit to reduce and or substantially eliminate self-interference via either hardware (e.g.,, a choke) or signal processing via a processor (e.g.,, a separate processor (not shown) or via processor 118). In an embodiment, the WTRU 102 may include a half-duplex radio for which transmission and reception of some or all of the signals (e.g.,, associated with particular subframes for either the UL (e.g.,, for transmission) or the DL (e.g.,, for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g.,, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g.,, temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g.,, directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g.,, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g.,, 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g.,, every STA), including the AP, may sense the primary channel. If the primary channel is sensed/detected and/or determined to be busy by a particular STA, the particular STA may back off. One STA (e.g.,, only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g.,, only support for) certain and/or limited bandwidths. The MTC devices may include a battery with a battery life above a threshold (e.g.,, to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g.,, MTC type devices) that support (e.g.,, only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g.,, containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g.,, such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g.,, handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g.,, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g.,, testing) wired and/or wireless communication network in order to implement testing of one or more components. The one or more emulation devices may be test equipment. Direct RF coupling and/or wireless communications via RF circuitry (e.g.,, which may include one or more antennas) may be used by the emulation devices to transmit and/or receive data.

The following abbreviations and acronyms may appear in this document:
6DOF 6 Degrees of Freedom
ACK Acknowledgement
ADU Application Data Unit
AF Application Function
AR Augmented Reality
AS Access stratum
AT Attention
BWP Bandwidth Part
BSR Buffer status report
CSI Channel State Information
CG Configured Grant
DG Dynamic Grant
DL Downlink
DMRS Dedicated Demodulation Reference Signals
FDD Frequency Division Duplex
FoV Field of View
gNB gNodeB
FPS Frames per second
HARQ Hybrid Automatic Repeat request
iBLER Initial Block Error Rate
LCH Logical Channel
LCP Logical control prioritization
MAC Medium access control
MCS Modulation and Coding Scheme
MT Mobile Termination
MTP Motion-to-photon
NAS Non-access stratum
NACK Negative Acknowledgement
NW Network
PDB Packet Delay Budget
PDCCH Physical Downlink Control Channel
PDCP Packet data convergence protocol
PDU Packet Data Unit
PER Packet Error Rate
PHY Physical layer
PSG Power Saving Gain
PSR Packet Success Rate
PUCCH Physical Uplink Control Channel
PUSCH Physical Uplink Shared Channel
PDSCH Physical Downlink Shared Channel
QoE Quality of Experience
RLC Radio link control
RTT Round trip time
SDAP Service data adaptation protocol
SR Scheduling Request
STD Standard Deviation
TDD Time Division Duplex
TE Terminal Equipment
TRP Transmission/Reception Point
UE User Equipment
UL Uplink
UPF User Plane Function
VR Virtual Reality
WTRU Wireless Transmit/Receive Unit
XR Extended Reality

An XR WTRU may correspond to any XR device and/or node. A XR WTRU may include, head mounted displays (HMD), optical see-through glasses and camera, see-through HMDs for AR and MR, mobile devices with positional tracking and cameras, and/or wearables. Additionally, several different types of XR WTRUs may be envisioned based on the function of the XR device, including display, camera, sensors, sensor processing, wireless connectivity, XR/media processing and power supply that are provided by one or more devices, wearables, actuators, controllers and/or accessories). One or more XR WTRUs may be grouped into a collaborative XR group for supporting any XR application, experience, and/or service.

In XR services and applications such as AR, VR, and cloud gaming, the traffic may consist of data and PDUs that may be associated with an application data unit (ADU) or PDU set. In XR services, the PDUs belonging to a PDU set may be associated with different spatial positions in the frame. For example, a number of PDUs in an PDU set transmitted in UL and/or received in DL may carry data associated with FoV spatial positions in the frame. Likewise, the other PDUs in the PDU set may carry non-FoV spatial positions in the frame.

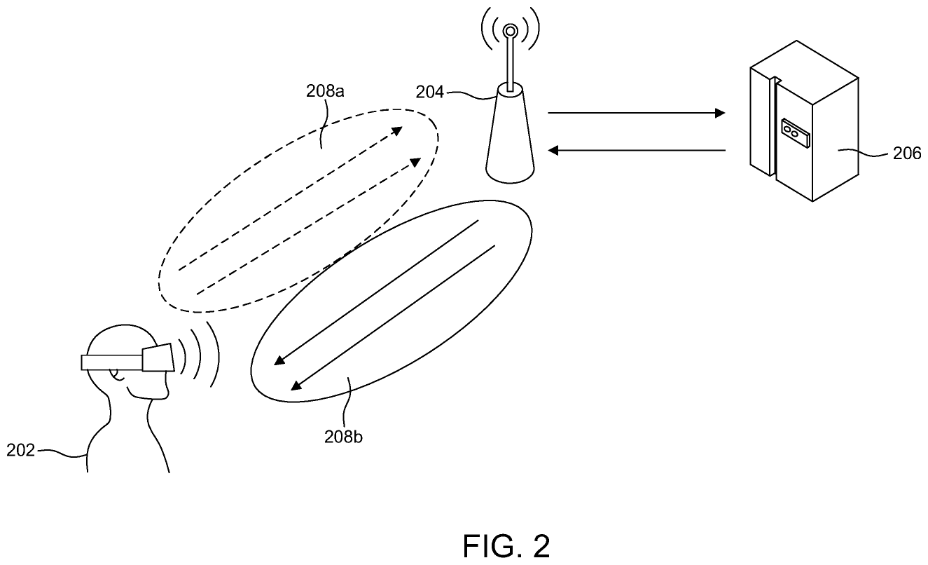

FIG. 2 is a diagram illustrating interactive and split rendering scenarios. As shown in FIG. 2, in interactive and split rendering scenarios, an XR WTRU 202 may transmit, to the base station 204, PDU sets in one or more flows in an UL 208a (e.g., consisting of pose, gesture, video data) and may receive, from the base station 204, associated PDU sets in different flows in a DL 208b (video, audio, haptics). Specifically, a PDU set received in the DL 208b in response to the PDU set transmitted in the UL 208a is expected to be within a strict RTT latency to ensure high QoE. The base station 204 may then receive and transmit data with the UPF/AF 206.

In XR services, the RTT latency may be related to motion-to-photon (MTP) latency, corresponding to delay between the movement of the user and the change of the device's display reflecting the user's movement. The inter-dependencies and association between the PDUs of a PDU set transmitted in an UL and received in a DL may result in different challenges for ensuring the the QoS in terms of RTT latency is met. Additionally, the PDU sets transmitted in an UL in one or more associated flows may be expected to be received by the application server (in the UL) and/or WTRU (in the DL) within a synchronization time window.

The different PDUs in an PDU set may contribute to a different user experience and may be associated with different spatial and/or temporal importance values. RTT latency is typically measured from an application in a WTRU or server to another application in a different WTRU (e.g., between UL PDU set and associated DL PDU set). Such an association between the UL and the DL PDU set may not be visible to the base station. If the scheduling of resources are performed without coordination and awareness of the association between the UL and the DL data, it may be challenging to guarantee that the RTT latency is achievable. Any fluctuations in the RTT latency may adversely impact the QoE achievable at the WTRU. Because the WTRU may have visibility into the UL and DL data and PDU sets (given that that WTRU is the source and destination of the data), solutions that leverage on a combination of lower layer mechanisms and application layer mechanisms at the WTRU to maintain the QoE may be beneficial.

One problem to be addressed for ensuring stable RTT and performing certain adaptations when there may be variations in the RTT, is how to efficiently handle data transmissions and ensure predictable RTT latency in scenarios with variable traffic patterns in the UL and/or in the DL.

In the embodiments described herein, the network may include any of a base station (e.g., gNB, TRP, RAN node, access node), core network function (e.g., AMF), and application function (e.g., edge server function, remote server function).

In the embodiments described herein, flows may correspond to any of: QoS flows or data flows (e.g., flow of data consisting of one or more PDUs or PDU sets), which may be associated with one or more QoS requirements (e.g., latency, data rate, reliability, RTT latency). Different flows, possibly originating from a common application source and/or intended to a common destination WTRU or group of associated WTRUs may be referred to as associated flows or correlated flows.

In the embodiments described herein, forwarding configuration may correspond to any of the following: radio bearers (e.g., data radio bearers (DRBs) and/or signaling radio bearers (SRBs)), logical channels (LCHs), logical channel groups (LCGs), configuration parameters in the individual layers within the AS protocol stack (e.g., SDAP, PDCP, RLC, MAC, PHY, other new protocol layers), parameters associated with logical channel prioritization (LCP) (e.g., priority, PBR, BSD), BWPs, carriers, radio links/interfaces (Uu links, SLs), and radio resources (e.g., set of one or more frequency/time/spatial resources such as timeslots, subcarriers, or beams. Radio resources may also be associated with configurated grants (CG), dynamic grants (DG) and/or any other resource grants or grant free resources.

In the embodiments described herein, mapping configuration may correspond to any of the following parameters and/or configurations associated with mapping from one or more: application data (e.g., ADU) flows, QoS flows (e.g., associated or non-associated) to one or more radio bearers, SDAP, PDCP, LCHs, carriers or component carriers (e.g., CCs in CA configurations), BWPs, and radio links/interfaces (e.g., Uu link or sidelinks), which may be used for delivering the PDUs in an UL direction and/or a DL direction.

In the embodiments described herein, XR application-aware data transmissions/receptions or XR application-aware QoS handling, may correspond to a PDU set or ADU handling. A PDU set (e.g., media unit, video frame) may comprise of one or more PDUs. A PDU set may be associated with PDU set-level QoS requirements (e.g., data rate, latency, error rate, reliability), which may be applicable for one or more or all PDUs associated with a PDU set. The different PDUs in a PDU set may be associated with individual PDU-level QoS requirements. Such associations and inter-dependencies may be visible to the AS-layers (e.g., with associated IDs) and/or handled at the AS layers with the awareness of the association during data transmission in UL and reception in DL.

In the embodiments described herein, XR application-aware data transmissions/receptions or XR application-aware QoS handling, may correspond to application/high layer importance/priority. The different PDUs in a PDU set or all PDUs in a PDU set may be associated with different application/high layer importance/priority values. Such high layer importance values may correspond to spatial importance (e.g., spatial position of the video frame whose data is carried by the PDU/PDU set, where PDUs or PDU set carrying FoV spatial positions may be associated with higher spatial importance than non-FoV spatial positions) or temporal importance (e.g., time sequence of the video frame who data is carried by the PDU/PDU set, where PDUs or PDU sets carrying base video frames such as I-frame may be associated with higher temporal importance than differential video frames such as P-frame or B-frame). Such importance values may be visible to the AS layers (e.g., with associated IDs/markers/indications), possibly enabled by application awareness, during data transmission and reception.

In the embodiments described herein, XR application-aware data transmissions/receptions or XR application-aware QoS handling, may correspond to QoS flow handling. The PDUs and/or PDU sets of an application may be encoded and delivered by the application to a WTRU (in UL) or a network (in DL) via one or more QoS flow or data flows. In this regard, the different QoS flows carrying the PDUs or PDU sets associated with an XR application may be visible to the AS-layers (e.g., with associated IDs) and/or handled at the AS layers with the awareness of the association during data transmission and reception.

Throughout the embodiments herein, WTRU actions, possibly related to application actions and/or AS-layer actions for ensuring and/or supporting differentiated QoS, may correspond to any of the following:

WTRU actions, possibly related to application actions and/or AS-layer actions for ensuring and/or supporting differentiated QoS, may correspond to determining the metadata of application (e.g., XR application). For example, determining metadata may involve determining any of the FoV/visual perimeters, 2D/3D size, border, spatial attributes, and boundaries of FoV, based on measurements in any spatial dimensions, including but not limited to longitude, latitude, altitude, depth, roll, pitch, and/or yaw in one more coordinate systems (e.g., cartesian, spherical). Determining metadata may involve determining the quality of the FoV content, including whether the FoV content is of high quality (which in the case of an image, may be quantified and assessed by the image resolution (e.g., number of density of megapixels). Determining metadata, may also involve determining the importance and/or priority of the FoV content. The importance may be associated with the spatial importance and/or temporal importance of content/data. The spatial and/or temporal importance value may indicate the absolute or relative importance associated with the FoV content. Spatial importance may be associated with one or more segments/tiles/slices/positions of the FoV in spatial dimension. Temporal importance may be associated with one or more frames/subframes of the FoV in the time dimension.

WTRU actions, possibly related to application actions and/or AS-layer actions for ensuring and/or supporting differentiated QoS, may correspond to determining and/or generating application content. For example, determining application content may involve determining and/or capturing the one or more 2D/3D images and/or video frames associated with a FoV boundary, perimeter, and/or border as defined by the FoV metadata by the WTRU or node for itself and/or on behalf of another WTRU or node. For FoV content mapping, the WTRU may determine the images and/or video frames using visual sensors (e.g., 2D/3D camera, lidar), RF sensors (e.g., RF transceiver, RADAR), and/or audio sensors (e.g., sonar). Herein, the mapping of a FoV may also be referred to as sensing of FoV content or capturing of FoV content. For example, determining application content may also include recording/capturing of audio frames, either as part of the real environment or as part of an overlaid sound-track/audio file with the audio file originating from a source other than the current real environment being mapped.

WTRU actions, possibly related to application actions and/or AS-layer actions for ensuring and/or supporting differentiated QoS, may correspond to performing measurements and reporting. For example, the WTRU may perform measurements of pose (e.g., 6DoD/3DoD orientation, location, position), rate of motion, and/or rate of movement of the user, WTRU and/or other objects (e.g., virtual or real) which the user may be interacting with. The WTRU may send and/or report the pose measurements to the network, periodically or when detecting event triggers (e.g., change in pose measurements above/below a threshold). For example, the WTRU may perform measurements of one or more of reference signals (e.g., SSB, CSI-SR, PRS, sidelink RS), GNSS signals, unlicensed carriers, ultra-wideband signals, LIDAR signals, visual signals, etc. In another example, the WTRU may perform measurements of the radio link interfaces associated with the WTRU (e.g., Uu link, SL). For example, the WTRU may trigger transmission and/or measurement of reference signals in other one or more WTRUs (e.g., via Uu link and/or sidelink). The WTRU may send measurement reports to the network and/or another WTRU.

WTRU actions, possibly related to application actions and/or AS-layer actions for ensuring/supporting differentiated QoS, may correspond to handling and/or forwarding of data and/or PDUs or PDU sets and handling QoS associated with PDUs or PDU sets. For example, data may include any of media/image/video frames, sensor data, and/or measurement data (e.g., pose measurements, link/channel measurements) determined by the WTRU, possibly for supporting an application/service/network request associated with the WTRU. For example, the WTRU may send and/or receive data, to or from one more destinations including RAN node (e.g., gNB), CN function/entity, application function (e.g., hosted in WTRU or in network). For example, the WTRU may perform splitting/merging of data/PDUs in one or more QoS flows into one or more forwarding configurations during transmission/receptions.

WTRU actions, possibly related to application actions and/or AS-layer actions for ensuring and/or supporting differentiated QoS, may correspond to handling and/or forwarding of information related to connectivity with network and/or other WTRUs. The handling and/or forwarding of information related to connectivity with network and/or other WTRUs may include, for example, sending capability information to the network, including capability for supporting one or more traffic flows with different XR traffic patterns (e.g., periodic/aperiodic, PDU sets with variable payload sizes), capability for performing application layer measurements (e.g., QoE measurements, application buffer measurements, RTT measurements), and capability for detecting changes to traffic patterns. The handling and/or forwarding of information related to connectivity with network and/or other WTRUs may include may also include, sending inter-WTRU coordination capability information to the network, including capability for supporting one or more interfaces, capability to coordinate and/or interact with other WTRUs (e.g., via SL interfaces), which may be co-located or non-co-located with the WTRU. The handling and/or forwarding of information related to connectivity with network and/or other WTRUs may include: receiving configuration information, including receiving RRC configuration from gNB and/or NAS-layer configuration from CN. Handling and/or forwarding of information related to connectivity with network and/or other WTRUs may include, sending and/or receiving assistance data to/from network associated with traffic, QoS, scheduling, for supporting UL/DL transmissions. The Handling and/or forwarding of information related to connectivity with network and/or other WTRUs may include, sending requests for radio resources and/or resource grants (e.g., dynamic grants, semi-static/configured grants).

In an embodiment, a WTRU may be configured to flexibly update the mapping configurations and/or forward configurations and the protocol stack including SDAP, PDCP, RLC, MAC, PHY and any new layers in the AS layers based on the detection of one or more configured triggering conditions.

The PDUs and/or PDU sets received in one or more QoS flows, with the same or different QoS requirement and/or characteristics, may be mapped to one or more forwarding configurations using mapping configurations. The different forwarding configurations may be configured to achieve and/or enforce different QoS when transmitting the PDUs or PDU sets. In an example, the PDUs of a PDU set received, from an application, in one or more QoS flows, may be mapped using a mapping configuration (e.g., at SDAP) to one or more forwarding configurations (e.g., DRBs with common/different PDCP entities). The forwarding configurations may be associated and/or grouped for achieving and/or ensuring PDU set level QoS. Upon mapping, the configuration (e.g., priority, PDB) at the forwarding configurations for achieving/enforcing PDU-level and/or PDU set-level QoS may be applied to the PDUs or PDU sets in the buffers associated with the forwarding configuration.

The PDUs of different PDU sets to be received, from an application, in different QoS flows, may have different expected QoS to be satisfied during transmission. Based on the determination of the expected QoS for the PDUs or PDU sets received or to be received in QoS flows, the WTRU may apply certain mapping and buffer and/or queue management mechanisms at one or more layers of the AS layer protocol stack (e.g., SDAP, PDCP, MAC) such that the expected QoS for the PDUs may be satisfied during transmission and/or upon reception at network. A similar approach may be applied when the WTRU expects to receive any of the PDU/PDU sets in a DL from the network.

For satisfying the QoS requirements of PDUs or PDU sets, the different layers in the forwarding configuration may be configured with different configuration parameters. For example, such configuration parameters may include support for AM/UM in RLC, LCP rules/restrictions, and associated LCH parameters (e.g., PBR, BSD, priority) at the MAC and number of HARQ transmissions. For satisfying QoS requirements, certain parameters may be configured in the PDCP (e.g., sequence number size, ROCH) and SDAP (e.g., mapping between QFI and radio bearers) sublayers.

Hereinafter, the term expected QoS may be used to denote the expected margin of a certain QoS metric (e.g., latency, data rate, reliability) before the arrival of the PDUs or PDU sets or when the PDUs or PDU sets are received at the WTRU (i.e., the QoS to be achieved and/or enforced when transmitting). The expected QoS may correspond to a time duration available at the WTRU for forwarding PDUs on a Uu link. The expected QoS may also correspond to the time-to-live (TTL) (e.g., maximum time available for processing and delivering) for an individual PDU or different PDUs in a PDU set. In this case, the expected QoS may be determined based on the indications and/or markers in the PDUs (e.g., QFI, timestamps, and/or PDU set ID in the PDU header) and/or based on usage of timers which may be set when receiving the PDUs or PDU sets and reset/stopped at the expiration of a configured time duration. Similar mechanisms (e.g., based on indications/markers and/or timers) may be applied for changing between different mapping and/or forwarding configurations for ensuring expected QoS.

In some examples, the expected QoS/TTL may be stricter or more relaxed than the default QoS metric associated with the PDUs or PDU sets. For example, if a PDU arrives late at the WTRU or the importance value of the PDU is indicated to be high (e.g., above a threshold), having experienced more delay and jitter at the application layer (e.g., due to encoder), the expected latency to be satisfied over the Uu link for the PDU will be lower than the default PDB that is typically used for sending the PDU. Alternatively, if a PDU arrives early or the importance value for the PDU is indicated to be low (e.g., below a threshold), the expected latency over the Uu link may be considered to be more relaxed than the PDB that is normally used for sending such PDUs.

The expected QoS may vary dynamically based on the QoS experienced during reception and/or importance/priority indications, where for a fixed QoS (e.g., PBR, PDB) an increase and/or decrease in the expected QoS prior to reception may translate to a decrease and/or increase in the expected QoS over the Uu link.

In an embodiment, a WTRU may be configured to perform a 1:1, N:1, or N:M mapping from one or more QoS flows to one or more forwarding configurations for enabling flexible utilization of radio bearers and resources while satisfying the QoS of the PDUs or PDU sets.

In an embodiment, the WTRU may be configured to support and to ensure that the data transmissions, consisting of PDUs or PDU sets in one or more flows in UL and/or in DL, are performed within an RTT latency value. The WTRU may support data transmissions within RTT latency and/or assist the network for ensuring RTT during transmissions based on any of the following: configurations, triggering events, conditions/criteria received from network and/or application.

The WTRU may be configured with one or more conditions and/or configurations associated to the treatment/handling of data/PDUs or PDU sets to be transmitted to the network or received from the network. Such conditions and/or configurations may be related to or may reflect an expected QoS to the achieved for the data/PDUs or PDU sets during transmission to the network (in UL), reception at WTRU (in DL), satisfy RTT or a change of such expected QoS.

The WTRU may support one or more procedures or functionalities for ensuring RTT when operating in WTRU-based and/or WTRU-assisted modes associated with handling the traffic/QoS of during data transmissions. The different modes for WTRU operation when ensuring RTT, may include a: (1) WTRU-based mode and/or (2) WTRU-assisted mode.

In the WTRU-based mode, the WTRU may perform selection and/or determination of one or more configurations, parameters, and/or mechanisms for satisfying QoS requirements (e.g., in UL, DL, RTT) associated with XR application aware data transmissions and/or reception, based on assistance information and/or configuration information received from network. An example of configuration information that is received from the network are QoS rules that are used by the WTRU to determine what QFI value to associate with a packet of data. QoS rules may be received from the network in a PDU session establishment response or a PDU session modification command.

In WTRU-assisted mode, a WTRU may assist the network for selection and/or determination of one or more configurations, parameters, and/or mechanisms for satisfying QoS requirements (e.g., in UL, DL, RTT) associated with XR application aware data transmissions/reception. The assistance may include providing assistance information and/or preferred configuration information (e.g., preferred parameters to be supported in mapping/forwarding configurations) to the network. For example, a WTRU may provide such assistance information to the network in a PDU session establishment request or a PDU session modification request.

A WTRU, based on such conditions, configurations, and/or operation modes described herein, may perform any of the following actions:

In one embodiment, based on conditions/configurations/operations described herein, a WTRU may perform a mapping of PDUs of a PDU set in one or more QoS flows to one or more resource or forwarding configurations. The resource configurations may include configured grant resources and/or dynamic grant resources. Such mapping may be done based on usage of one or more configured mapping configurations (e.g., determining mapping configuration parameters, dynamic activation and/or deactivation) and other conditions, threshold values, and/or configurations described herein.

In one embodiment, based on conditions, configurations, and/or operations described herein, a WTRU may determine and/or select a set of resource or forwarding configurations and/or parameters of resource and/or forwarding configurations for transmitting PDUs of a PDU set. Such determination and/or selection may be done based on usage of one or more configured forwarding configurations, associated parameters and other conditions and/or threshold values and/or configurations described herein.

In one embodiment, a WTRU may send information associated with supporting XR/application awareness and/or QoS handling (e.g., association of PDUs to PDU sets, association between UL PDU set and DL PDU set, RTT latency) to the network, possibly for enabling the network to have awareness of the WTRU actions (e.g., transmission/reception of UP and CP data associated with XR traffic) and/or application and/or QoS configurations/parameters supported by WTRU.

The information associated with XR/application awareness may be sent by the WTRU to the network via at least one or more of the following message types: assistance information; preferred configuration information (e.g., preferred forwarding and/or resource configurations/parameters to apply in the UL/DL); status information and/or indication (e.g., associated with any of AS-layers); measurement/status reports (e.g., WTRU pose information, channel/link measurements, buffer occupancy measurements); and/or request and/or response messages.

The information may be sent by a WTRU: periodically (e.g., using one or more configured periodicity values), periodically/dynamically (e.g., when detecting triggering events and/or conditions described herein), as an update message (e.g., when detecting a change in information sent previously), and/or on a semi-persistent basis (e.g., sent with a periodicity value over a time window and/or duration). The WTRU may switch between a first periodicity value and a second periodicity value for sending information, which may be based on the type of event detected (e.g., change in RTT). In another example, the WTRU may change between sending information periodically and aperiodically based on whether any change and/or amount of change is determined in the information sent/reported.

The WTRU may send the information and/or indications to the network via any of the following: RRC signaling and/or messages (e.g., via SRB1, SRB2, SRB3, SRB4); control PDUs associated with any of the AS layers (e.g., SDAP control PDU, PDCP control PDU); UL MAC CE (e.g., BSR, pre-emptive BSR, elastic BSR which may be scalable/adjustable by sending subsequent indications, possibly without cancelling an earlier BSR); UCI (e.g., SR, feedback, ACK/NACK, CSI); PUCCH; PUSCH; non-AS (NAS) layer signaling (e.g., PDU session related messages); application layer signaling/messages.

When the information and/or indications are sent to the network in a NAS message such as a PDU session establishment request or a PDU session modification request, the information/indications may be received by the SMF and used by the SMF to derive QoS rules and/or QoS profiles for the PDU Session. The SMF may also consider PCC rules that were received from the PCF when deriving QoS rules and QoS profiles for the PDU session. The SMF may then forward the QoS rules to the WTRU in a PDU session establishment response or a PDU session modification command. The SMF may then forward the QoS profile to the base station in an N2 message. The QoS profiles may be enhanced to include the information that is described below, thus enabling the network to have better awareness of the application/QoS configurations/parameters supported by WTRU.

The information sent by the WTRU to the network may include identifiers and/or IDs. For example, the WTRU may send one or more IDs and/or indexes that include any of the following: IDs associated with application (e.g., application ID, service ID, session ID, application configuration ID); group ID (e.g., associated with group of QoS flows, group of forwarding configurations, group of devices/WTRUs); IDs of individual QoS flows, mapping configurations, forwarding configurations; data type, message ID (e.g., PDU set ID, PDU ID, IDs associated with pose information, FoV information, media/video frame information); and/or association ID (e.g., ID or sequence number indicating the association between one or more UL PDUs or PDU sets/flows and one or more DL PDUs or PDU sets/flows).

The information sent by the WTRU to the network may include priority of applications supported by a WTRU. For example, the WTRU may send IDs of the applications supported and/or information on the relative and/or absolute priority values associated with the supported applications.

The information sent by the WTRU to the network may include data flows associated with the application. For example, the WTRU may send the number and/or IDs associated with the data and/or QoS flows supported per-application. The WTRU may also send information on the relative/absolute priority values associated with the data and/or QoS flows of the different applications supported.

The information sent by the WTRU to the network may include devices associated with the application. For example, the WTRU may send the number and/or IDs associated with the devices supported and/or the association of the devices per-application.

The information sent by the WTRU to the network may include data/Traffic types associated with the data flows per-application. For example, the WTRU may send information on different data/QoS flows associated with an application, where the data type may include video data (e.g., I-frame data, P-frame data, B-frame data), RGB-D data, 360 degrees video data, haptics data, pose and/or positioning data, and/or audio lata.

The information sent by the WTRU to the network may include Traffic characteristics and/or parameters of data and/or traffic associated with the data, QoS flows, and/or PDU sets per-application. For example, the WTRU may send information on traffic characteristics and/or patterns of the different data and/or QoS flows associated with an application, including whether the data is periodic, aperiodic, semi-persistent, quasi-periodic, etc. The traffic characteristics may include the one or more periodicity values of the flow.

For example, the WTRU may send information on the number of PDUs expected per PDU set in one or more flows per-application. The information of number of PDUs per PDU set may also include statistical and/or distribution information such as mean, minimum, maximum, and/or standard deviation values. The information related to PDU set may include size of the PDU set (e.g., total payload, number of PDUs in PDU set), indication of start/first and/or end/last PDU of the PDU set, and an indication of the association/dependency of the PDUs in a PDU set (e.g., ID of PDU set, importance/priority value).

For example, the WTRU may send information related to the jitter in an UL and/or in a DL. Such jitter information which may be sent on a per flow, per-PDU set or per PDU basis, may include the range, mean, maximum and minimum value.

For example, the WTRU may send indications when detecting any changes to the UL/DL traffic patterns (e.g., changes to periodicity, changes to mean payload sizes, changes to jitter range)

For example, the WTRU may send information on regarding a traffic pattern prediction in a UL and/or a DL for upcoming data (e.g., timing, size, importance of data to be received, uncertainty and/or confidence level of prediction).

In an example, the WTRU may send information on whether the PDU and/or PDU sets transmitted in UL may be followed by ACK/NACK feedback indications, which the WTRU may expect to receive from the application layers (e.g., TCP, RTP) and/or lower layers (e.g., ARQ, HARQ) within a time window/duration after UL transmission.

Similarly, the WTRU may send information on whether the PDU and/or PDU sets received in DL may be followed by ACK/NACK feedback indications, which the WTRU may expect to transmit to the application layers (e.g., TCP, RTP) and/or lower layers (e.g., ARQ, HARQ) within a time window/duration after DL reception.

The information sent by the WTRU to the network may include buffer information at application layers/higher layers/AS layers. For example, the WTRU may send information on the amount of data payload or the buffer level (e.g., with respect to one or more configured threshold values) at the application, including data waiting to be delivered to lower layers for UL transmission and data received in DL which may be waiting to be consumed/depleted/processed. Such buffer information may be reported in terms of the estimated or measured time duration for the data waiting in the buffer before delivered to lower layers or consumed by application, for example. Suffer buffer information may be reported in terms of rate of data delivered to lower layers or rate of data consumption/depletion at higher layers (e.g., determined as ratio of payload size and time duration).

For example, the WTRU may send similar information on the amount of data payload or the buffer level (e.g., with respect to one or more configured threshold values) at the higher layers (e.g., NAS layer) and/or AS layers (e.g., in SDAP, PDCP, RLC, MAC, LCHs, LCGs).

The information sent by the WTRU to the network may include QoS requirements or expected QoS associated with the data. For example, the WTRU may send the QoS requirements or expected QoS of the one or more flows associated with application, including data rate, latency, reliability, and/or absolute/relative priority values. The information on QoS requirements may also include statistical/distribution information such as mean, minimum, maximum, and standard deviation values.

The WTRU may also indicate that such QoS requirements or expected QoS may be supported on different QoS granularities such as: per-PDU, per-PDU subgroup (e.g., one or more PDUs) within PDU set, per PDU set, per-group of PDU sets, per flow, per session. The WTRU may also indicate a time window (e.g., start time, duration, end time) during which such QoS requirements or expected QoS may be applicable to the different QoS granularities.

The information sent by the WTRU to the network may include RTT latency information. For example, the RTT latency information provided by WTRU may include end-to-end-to-end latency (e.g., application in WTRU to application in server to application in WTRU). Such RTT latency may include motion-to-photon (e.g., delay between the movement of the user and the change of the device's display reflecting the user's movement), motion-to-audio and motion-to haptics, for example. The RTT information may be provided by WTRU at different granularities including on a per-PDU, per-PDU set, per flow, and per-session basis.

For example, the RTT latency information provided by WTRU may include only the latency components associated with over-the-air UL transmission and DL reception (e.g., over Uu link) and/or latency in the network (e.g., upstream and downstream). Such RTT latency may or may not include the latency at the application layer (e.g., processing, rendering, encoding/decoding latency).

The information sent by the WTRU to the network may include flow synchronization. For example, the WTRU may send information on synchronization, including delay difference between one more PDUs or PDUs sets in one or more correlated flows of the same and/or different devices/users (e.g., visual-tactile synchronization delay, audio-tactile synchronization delay). Such synchronization delay differences may refer to the delay between the arrival of the last PDU of a PDU set in a first flow and the arrival of the last PDU of a PDU set in an associated second flow, for example. For example, the WTRU may send information on synchronization, including delay difference between unicast and multicast flows (e.g., for 1-to-M and N-to-M interactions).

The information sent by the WTRU to the network may include pose information (e.g., orientation, position/location). For example, the pose information may be associated with the measurements in any spatial dimensions (e.g., 6DoF, 3DoF), including but not limited to longitude, latitude, altitude, roll, pitch and yaw in one or more coordinate systems (e.g., cartesian, spherical).

In an example, the pose information sent by the WTRU may be associated with the orientation and/or position/location of the WTRU. The WTRU may also send information on the movement of the WTRU (e.g., rate of movement in terms of linear movement (e.g., distance/sec) or rotational movement (e.g., degrees/sec). Pose information may include uncertainty information (e.g., certainty or reliability in a predicted pose/movement).

The information sent by the WTRU to the network may include capability information on associated with connectivity. For example, information on interfaces may include the number and/or types of interfaces (e.g., NR Uu, NR SL, WLAN, Bluetooth), supported by the WTRU. For example, the capability information on interfaces, possibly supported by WTRU and/or required by WTRU for supporting any of the WTRU actions/behaviors, may include any of the following: bandwidth, BWP, number of carriers, number of transmit antennas, number of receive antennas, etc.

The information sent by the WTRU to the network may include capability information associated with WTRU actions/behaviors. For example, the capability information related to WTRU actions, including visual sensing, possibly supported by WTRU (e.g., sensors, camera associated with WTRU) and/or required by WTRU may include any of the following: FoV resolution (e.g., megapixel count), rendered viewports (e.g., viewport ID), FoV size (e.g., 120 degrees), aperture size, shutter lag and startup time, image quality (e.g., minimum/maximum range), zoom lens options, image stabilization, exposure settings, battery life, sound/audio, display calibration (e.g., corrections applied for distortion and chromatic aberration), and capability to merge overlapping frames from different angles (e.g., stitching frames from individual captures together for panoramic image/video).

The information sent by the WTRU to the network may include preferred configuration information. For example, the WTRU may send to the network one or more preferred mapping configurations forwarding configurations, and/or resource configurations (e.g., CG, DG) including specific parameters associated with the forwarding/resource configurations, for supporting any of WTRU actions, that may be performed/supported by the WTRU and/or any another associated WTRU.

The forwarding configurations sent by WTRU associated with the supported and/or requested UP/CP configurations (e.g., radio bearers, LCHs, links) may include latency requirements. In an example for PDU, latency requirements may be expressed in terms of packet delay budget (PDB) associated with IP packets/PDUs. In an example for PDU set, latency requirements may be expressed in terms of PDU set delay bound or frame delay budget associated with the PDU set (e.g., video/media frames).

The forwarding configurations sent by WTRU associated with the supported and/or requested UP/CP configurations (e.g., radio bearers, LCHs, links) may include data rate requirement (e.g., Mbps). In an example for PDU, data rate may be expressed in terms of bit rate (min, max, average, guaranteed) associated with one or more PDUs (e.g., individual PDU, group of PDUs, burst). In an example for a PDU set, data rate may be expressed in terms of bit rate (minimum, maximum, average, guaranteed) associated with one or more PDU sets (e.g., video/media frames).

The forwarding configurations sent by a WTRU associated with the supported and/or requested UP/CP configurations (e.g., radio bearers, LCHs, links) may include reliability requirements. In an example, reliability may be expressed in packet error rate (PER). In an example PDU set, reliability may be expressed in frame error rate or PDU set error rate.

The forwarding configurations sent by a WTRU associated with the supported and/or requested UP/CP configurations (e.g., radio bearers, LCHs, links) may include absolute/relative importance/priority values associated with the UP/CP configurations (e.g., radio bearers, logical channels, links).

The forwarding configurations sent by a WTRU associated with the supported and/or requested UP/CP configurations (e.g., radio bearers, LCHs, links) may include a LCP configuration. For example, the WTRU may indicate the LCP rules and/or restrictions (e.g., restrictions associated with mapping from DRB and/or LCHs to configured resource grants) that may be applied for a set of forwarding/resource configurations (e.g., CG), whether such LCP rules/restrictions may be temporarily changed for a time duration, conditional LCP configurations applicable when detecting certain configured events (e.g., surge in number of PDUs/data with high QoS requirements), fallback and/or default LCP configurations.

In an example, the WTRU may associate and/or indicate weight/probability values to different forwarding/resource configurations when sending request related to preferred configuration. In this case, the weight/probability value may be determined based on the likelihood of a configuration to be applied during transmission and other application and/or AS-layer information and/or indication. The network may use such weight and/or probability information for determining and providing, to a WTRU, a combined configuration and/or for activating and/or deactivating a configuration that may match with the weight values indicated by WTRU.

The information sent by the WTRU to the network may include an indication for activating and/or deactivating configurations. For example, the WTRU may send an indication to the network to request to activate and/or deactivate a mapping, forwarding, resource, and/or configuration, and/or parameters associated with the configurations (possibly preconfigured in the WTRU). The WTRU may include the ID of the configuration and/or parameter when sending the request indication. In an example, the request to activate/deactivate a configuration may be accompanied with information on the WTRU action (e.g., splitting/merging QoS flows/PDU sets/PDUs).

The information sent by the WTRU to the network may include measurements related to the application and/or AS layer. For example, the WTRU may send RSRP, RSRQ, RSSI measurements of the signals, channels, radio links, carriers, possibly associated with the one or more WTRU actions. For example, the WTRU may send pose and/or positioning measurements (e.g., location information, pose in 6DoF, rate of user/WTRU motion/movement). For example, the WTRU may send measurements and/or estimations related to RTT/MTP, application buffer level, buffer depletion time, depletion rate. For example, the WTRU may send the QoS related measurements related to number of PDUs or PDU sets received possibly over a time duration, change in the QoS (e.g., increase/decrease in data rate, latency, reliability), time-to-live associated with the PDUs or PDU sets, and remaining time for delivering the PDUs or PDU sets.

The information sent by the WTRU to the network may include uncertainty information. For example, for any of the information sent/reported by WTRU including application layer information (e.g., pose information, QoS flows, MTP latency) and AS-layer information (e.g., preferred forwarding configurations, RTT latency), the WTRU may also send the uncertainty associated with the information. In an example where the WTRU may perform prediction or estimation of a parameter (e.g., RTT latency), the WTRU may indicate to the network the uncertainty associated with the estimation/prediction.

The embodiments described herein and below may use one or more of the above descriptions (e.g., assistance information, preferred configurations) sent by WTRU to the network.

In an embodiment, the WTRU may receive configuration/assistance information for enabling the WTRU for supporting any procedures, mechanisms, rules, actions etc., associated with ensuring RTT latency during UL transmissions and/or DL receptions of data/PDUs or PDU sets in one or more data and/or QoS flows.

The configuration and/or assistance information may be received by WTRU from network periodically (e.g., with one or more configured periodicity values), aperiodically/dynamically (e.g., status indication/information or request/request messages) and/or on semi-persistent basis (e.g., sent with a periodicity value over a time window/duration).

The WTRU may receive the configuration and/or assistance information via any of the following: RRC signaling and/or messages (e.g., dedicated/unicast signaling, broadcast/SIB); control PDUs associated with any of the AS layers (e.g., SDAP control PDU, PDCP control PDU); DL MAC CE; DCI; PDCCH; PUSCH; non-AS (NAS) layer signaling (e.g., a PDU session establishment response or a PDU session modification command); application layer signaling/messages.

The configuration and/or assistance information which may be received by a WTRU from the network may include a combination of one or more of the following:

The configuration and/or assistance information which may be received by WTRU from the network may include mapping, forwarding, and/or resource configurations and/or parameters. For example, the WTRU may receive one or more configurations and/or sets of configuration parameters to be applied at different layers of the AS protocol stack (e.g., RRC, SDAP, PDCP, RLC, MAC, PHY or any new layer).

The configurations parameters to be applied at different layers may include: (1) SDAP/PDCP; (2) PDCP; (3) RLC; (4) MAC; and (5) PHY.

The SDAP/PDCP parameter may be one-to-one, one-to-M or N-to-M mapping configurations, markings, indications, IDs to apply (e.g., associated with handling QoS flows, PDU sets, association information between UL and DL PDUs or PDU sets), and/or a range of values associated with importance/priority information to identify in the PDUs or PDU sets. A SDAP/PDCP mapping configuration may refer to information that is used to map a packet at the SDAP layer to a PDCP entity and/or sublayer. The PDCP parameter may be IDs and sequence numbers to apply, RoCH configuration, security/encryption parameters, and/or packet duplication configurations. The RLC parameter may be a parameters for AM/UM/TM operation. The MAC parameter may be LCH parameters (e.g., priority, PBR, BSD for PDU and/or PDU set level), LCP configurations (e.g., rules/restrictions/policy for PDU and/or PDU set level handling, time duration for changing between different LCP rules/policy), and/or configurations for multiplexing/assembly The PHY parameter may be MCS and/or HARQ configurations.

For example, the WTRU may receive one or more resource configurations, including: (1) configured grant resources/configurations for UL data transmissions; (2) semi-persistent scheduling (SPS) resources/configurations for DL data receptions; (3) dynamic grant resources for UL data transmission (e.g., triggered by UCI, SR, BSR, MAC CE); and/or (4) dynamic scheduling resources for DL data receptions (e.g., triggered by DCI, PDCCH, MAC CE).

The parameters associated with CG resources/configurations may include periodicity, start offset, duration, BWPs, numerology/SCS values, number of PRBs, number of occasions, number of PUSCH slots per occasion, maximum number/duration/length of PUSCH, one or more MSC values for the grant, antenna ports, etc. The parameters associated with SPS resources/configurations may include periodicity, start offset, duration, BWPs, numerology/SCS values, number of PRBs, number of occasions, number of PDSCH slots per occasion, maximum number/duration/length of PDSCH, one or more MCS values for the grant, antenna ports, etc.

A WTRU may receive at least one set of configuration parameters associated with a default configuration, which may be activated and/or used during normal scenarios for transmitting/receiving data. The WTRU may also receive another set of configuration parameters which may be associated with exceptional operation and may be activated and/or used when detecting any of the triggering events and/or conditions described herein.

A WTRU may receive default priority values associated with the resource configurations (e.g., CG). For example, a first resource configuration may be associated with a first priority value and second resource configuration may correspond to a second priority value. The first and second resource configurations may be associated with the same application and a first set of priority values may be intended to achieve a default QoS performance (e.g., default latency, default RTT, default data rate) and a second set of priority values may be intended to achieve exceptional QoS performance (e.g., surge/burst data rate, very low latency, very low RTT) for the PDUs or PDU sets using the first and second resource configurations during transmission.

The configuration and/or assistance information which may be received by WTRU from network may include AS layer status information and/or indications. The AS layer status information/indications may include identifiers/IDs. For example, the WTRU may receive information on one or more IDs to apply during transmission/reception including any of the following: (1) WTRU IDs, e.g., C-RNTI, I-RNTI, NAS IDs, TMSI/IMSI; (2) IDs associated with application (e.g., application ID, service ID, session ID, application configuration ID); (3) group ID (e.g., associated with group of QoS flows, group of forwarding configurations, group of devices/WTRUs); (4) IDs of individual QoS flows, mapping configurations, forwarding configurations; (5) data type/message ID (e.g., PDU set ID, PDU ID); (6) resource configuration ID (e.g., CG IDs, SPS IDs).

The AS layer status information and/or indications may include may include status of forwarding/resource configurations. For example, the WTRU may receive the information on QoS achieved/achievable (e.g., RTT latency) when using one or more forwarding/resource configs. For example, such information may be received by WTRU in terms of the data-rate, latency (e.g., expected, remaining latency), RTT latency, reliability, priority achievable and/or achieved when transmitting and/or receiving data and/or PDUs or PDU sets. The WTRU may also receive statistical/relative/absolute information associated with the QoS achieved/achievable, in terms of mean, maximum, minimum, and/or standard deviation.

The AS layer status information and/or indications may include flow control. For example, the WTRU may receive from network explicit or implicit flow control indications indicating whether to start, increase, decrease, suspend, and/or stop transmission of PDUs or PDU sets, in terms of achieving an indicated rate of transmission, latency, RTT latency, reliability, in one or more forwarding configurations.

The configuration/assistance information which may be received by WTRU from network may include validity information. For example, the WTRU may receive validity information associated with the forwarding and/or resource configurations, indicating whether and/or when the configurations may be considered to be valid or invalid, based on one or more of triggering events and/or conditions. The WTRU may also receive information on whether the configurations are to be deactivated and/or released when determining them to be invalid. For example, the WTRU may receive information on whether the configurations are to be considered as valid/invalid based on the RRC state of the WTRU (e.g., CONNECTED, INACTIVE, IDLE) and/or when transitioning between different RRC states.

The configuration and/or assistance information which may be received by WTRU from network may include threshold values. One threshold value may be a buffer occupancy threshold. For example, the buffer occupancy threshold values associated with any of forwarding configurations may indicate the maximum/minimum amount of data/PDUs or PDU sets (e.g., in terms of total payload size/volume) that may be included in the buffer (e.g., application layer buffer, AS-layer/LCH buffer).

Another threshold value may be a PDU or PDU set payload size. For example, the payload size threshold values may be associated with one or more upper and/or lower bound values corresponding to the total size of payload (e.g., in the units of bits or bytes) of one or more PDUs or PDU sets. In another example, the payload size threshold values may be associated with one or more upper and/or lower bound values corresponding to the total number of PDUs in a PDU set.

Another threshold value may be RTT latency. RTT latency threshold values may be associated with one or more upper and/or lower bound values corresponding to maximum and/or minimum RTT latency value. Such RTT latency threshold values may be intended to identify and/or determine the maximum and/or minimum RTT latency tolerated by the network, application and/or WTRU. The RTT latency may be a result of delays due to processing, jitter, transmission, and/or congestion,.

Another threshold value may be RTT difference threshold values. For example, RTT difference threshold values may be associated with one or more upper and/or lower bound values corresponding to the difference between a first RTT latency value (e.g., default RTT latency) and a second RTT latency value (e.g., new and/or modified RTT latency value).

Another threshold value may be expected threshold time values: For example, the WTRU may receive one of more expected threshold time values or expected time of arrival (ETA) threshold values corresponding to the expected time for receiving a PDU or PDU set in a data flow, where the PDU may be the first and/or last PDU associated with an PDU set or any of the subsequent PDUs after receiving the earlier PDUs.

In another example, the ETA threshold values may be associated with the expected latency for the second PDU or PDU set after receiving and/or transmitting the first PDU or PDU set with a first latency value. In an example, the second PDU may correspond to the last PDU of a PDU set.

In another example, the ETA threshold values may be associated with the expected latency for the PDUs or PDU set in a second associated data and/or QoS flow after receiving and/or transmitting the PDUs or PDU set in a first data/QoS flow with a first latency value.

In another example, an ETA threshold value may be associated with a time duration or timer value. For example, the WTRU may start a timer at a time instance when receiving/transmitting the first PDU and stop the timer when the timer expires at the time instance corresponding to the threshold time value and/or when receiving and/or transmitting the second PDU (e.g., first and second PDU may be associated with the same PDU set).

Another threshold value may be expected data rate (EDR) threshold values. For example, the WTRU may receive one or more expected data rate threshold (EDR) values associated with the data rate expected for receiving/transmitting PDUs or PDU sets in one or more data/QoS flow. The data rate may correspond to any of the following units: PDUs or PDU sets per second, frames per second, and/or bits/bytes per second.

In another example, the EDR threshold values may be associated with the expected data rate for the second PDU/PDU set after receiving/transmitting the first PDU and/or PDU set with a first data rate value. In another example, the EDR threshold values may be associated with the expected data rate for the PDUs or PDU sets in a second associated data/QoS flow after receiving/transmitting the PDUs or PDU sets in a first data and/or QoS flow with a first data rate value.

Another threshold value may be expected reliability threshold values. For example, the WTRU may receive one or more expected reliability threshold (EER) values associated with the reliability expected for receiving PDUs or PDU sets in one or more data and/or QoS flows. The reliability values may correspond to packet error rate, frame/PDU set error rate, and/or probability of error.

In another example, the EER threshold values may be associated with the expected reliability for the second PDU/PDU set after receiving/transmitting the first PDU/PDU set with a first reliability value. In another example, the EER threshold values may be associated with the expected reliability for the PDUs or PDU sets in a second associated data/QoS flow after receiving and/or transmitting the PDUs or PDU sets in a first data and/or QoS flow with a first reliability value.

Another threshold value may be a pose difference threshold. For example, pose difference threshold value may correspond to the difference between the measurement of pose information at a first time instance and a second time instance, where the time instances may correspond to any of the following units: time slots, symbol duration, SFN and seconds/milliseconds.

Another threshold value may be a WTRU movement threshold value. For example, the WTRU movement threshold may correspond to the difference between the location or rotation angle of WTRU between a first time instance and a second time instance, where the time instances may correspond to any of the following units: time slots, symbol duration, and/or SFN, seconds, and/or milliseconds.

Another threshold value may be a correlation time window. For example, the correlation time window may correspond to the minimum time difference between two triggering events (e.g., pose information measurements, QoS events), where the two events may be considered as correlated between one and another when they occur within the correlation time window. When the two events occur at time instances beyond the correlation time window, they may be considered as independent. In an example, the WTRU may use the correlation time window for determining whether to send an indication to the network (e.g., indicating change in RTT latency, change WTRU location/movement or change in QoS).

The embodiments described herein and below may use one or more of the above configuration/assistance information received by WTRU from the network.

The WTRU may be configured with one or more events and/or conditions related to triggering one of the WTRU actions described above, including sending assistance information/indications to the network, receiving configuration and/or assistance information from network, sending an indication and/or request for changing resource configurations, sending indication and/or request for changing forwarding configurations.

Such triggering events and/or conditions may be related to ensuring RTT latency and/or for meeting expected RTT latency when transmitting and/or receiving PDUs or PDU sets in one or more associated QoS flows. Such triggering events and/or conditions may dictate whether and which action may be performed by the WTRU. Such triggering events and/or conditions may dictate when (at what time instant) an action may be performed by the WTRU (i.e., any of events, conditions, and/or criteria described herein are satisfied). For example, the WTRU may determine and/or select a resource configuration (e.g., CG, SPS, DG) for meeting an expected RTT based on detection of one or more triggering events and/or conditions. Such conditions may be based on one or more of the following:

Such triggering events and/or conditions may be based on an indication and/or information from the network. For example, the WTRU may receive, from the network (e.g., gNB), an indication and/or information on the expected and/or achievable RTT for transmission and/or reception over the Uu link (in UL and/or DL). The information may be received semi-statically, dynamically, and/or during or upon configuration. For example, the WTRU may trigger an action (e.g., determining and/or selecting a mapping, forwarding or resource configuration), described herein, based on the indication and/or information received from the network.

For example, the expected and/or achievable RTT may be indicated on the basis of per PDU, per-PDU set, per-QoS/data flow, per forwarding configuration, and/or per-resource configuration. In another example, the WTRU may receive, from the network, the information on the expected and/or achievable RTT implicitly based on one or more of the following: number of times HARQ feedback is received, size and/or timing for allocation of resource grants (e.g., configured grant, dynamic grants, etc.), allocation of retransmission grant corresponding to one or more forwarding configurations (e.g., LCHs/DRBs/BWPs), and/or de-prioritization of PUSCH/grant for one or more LCHs due to intra/inter WTRU prioritization.

For example, the WTRU may be triggered to perform any of the WTRU actions described above when receiving an indication from the network (e.g., in RRC, MAC CE, other control PDU or DCI). The indication received by the WTRU may be related to the change and/or update in forwarding and/or resource configuration at the WTRU and/or expected RTT associated with the one or more PDU sets and/or QoS flows.

Such triggering events and/or conditions may be based on an indication and/or information from an application and/or higher layers. For example, the WTRU may perform any of the WTRU actions when receiving an indication from application/higher layers. Such indication may include information on the change of traffic characteristics/patterns associated with the generation/processing/reception PDUs or PDU sets in one or more QoS/date flows. For example, an application that is hosted in the TE part of the WTRU may send this indication to the MT part of the WTRU in an AT command.

In an example, the application may indicate to the WTRU the information on the expected number of QoS flows which may be associated with the application, expected number of PDUs per PDU set, expected frame/PDU set in a subsequent time instances (e.g., next frame generation instance), expected change in the distribution of importance/priority of PDUs generated, expected increase/decrease in latency (e.g., due to processing at codec/application), expected increase/decrease in RTT, and/or jitter for delivering the PDUs or PDU sets in UL and/or DL, expected change in the time-to-live associated with PDUs or PDU sets, and/or expected change in the WTRU, or user motion or movement (e.g., increase or decrease in rate of motion).

For example, the WTRU may receive an indication from an application and/or higher layers indicating the arrival of one or more PDUs or PDU sets (e.g., in a batch/burst) from an application in the WTRU (for UL) or from application in network (in DL). The information on the arrival of the PDUs or PDU sets may include the expected timing (e.g., time slot/frame) of PDU/PDU set generation at application, and expected timing of reception at WTRU, for example. Such information may be indicated to the WTRU via timestamps and/or sequence numbers.

For example, the WTRU may be triggered to perform any of the WTRU action(s) based on an indication of importance or priority for the transmitting PDUs or PDU sets. The WTRU may trigger an action (e.g., change forwarding/resource configuration) for sending possibly delayed PDUs with compensation (e.g., low latency) when receiving an indication containing a importance/priority value higher than a threshold.

Such triggering events and/or conditions may be based on a buffer status and loading at forwarding configurations (e.g., DRBs/LCHs). Such buffer status may include at least a condition associated with any of the following or combinations of measurements (e.g., compared to a threshold): (1) the amount of PDUs or PDU sets in one or more buffers associated with forwarding configurations, possibly over a period of time; (2) the rate of arrival or departure of the PDUs or PDU sets in one or more buffers associated with forwarding configurations; (3) the average, maximum, minimum size/volume of PDUs or PDU sets in buffers associated with forwarding configurations (e.g., number of PDUs in LCH buffer); (4) measure of the amount of time spent by one or more PDUs or PDU sets in buffers associated with forwarding configurations; and/or (5) the number of forwarding configurations meeting a condition/threshold associated with the amount of data, arrival rate, PDU or PDU set size (e.g., total payload size).

For example, a WTRU may perform any of the actions described herein (e.g., change the forwarding configuration and/or change resource configuration) if at least one PDU or PDU set in a forwarding configuration (e.g., UL LCH buffer waiting to be transmitted in UL and/or DL LCH/higher layer buffer waiting to be processed) is in the buffer for a period of time larger than a threshold time value. For example, a WTRU may perform any of the actions described herein (e.g., send a report or status indication) if the buffer status of forwarding configuration exceeds a threshold.

For example, other buffer status metrics that may be monitored for determining the expected QoS include the number of PDUs or PDU sets buffered which are above/below a configured threshold in one or more associated forwarding configurations, and/or the rate of PDU or PDU set arrival or departure in the buffer with respect to a configured arrival/departure rate.

In another example, the WTRU may determine the number of PDUs or PDU sets received over a time duration/window for determining whether the rate of PDUs received (e.g., from higher layers for UL transmission or from network for DL reception) is within the range expected for the QoS. For example, such time duration/window may be used for determining whether the PDUs received from network are received within an RTT latency. The WTRU may then determine and/or select a mapping configuration for adjusting/compensating the expected QoS if the PDUs or PDU sets are received outside of the range expected for QoS.

Such triggering events and/or conditions may be based on a change in one or more configurations at a WTRU. For example, the WTRU may be triggered to perform a WTRU action(s) (e.g., sending an indication/report to network) when determining a change to a mapping configuration, forwarding configuration and/or resource configuration, including changing at least one of the parameters at the mapping configuration (e.g., mapping a QoS flow to a new forwarding configuration), DRB/LCHs (e.g., priority, PDB, PBR), LCP configuration and/or resource configuration/parameters (e.g., CG/DG/SPS). For example, the WTRU may be triggered to perform a WTRU action(s) when the CDRX/DRX configuration and any of the associated parameters applied at the WTRU is modified/updated, which may possibly impact the transmission/reception pattern and/or QoS (e.g., RTT) achievable during data transmission.

Such triggering events and/or conditions may be based on timing/timestamp information, possibly associated with expected QoS (e.g., RTT latency). For example, the WTRU may track the timing related information (e.g., timestamp, sequence number, marker or timing control PDU) in the one or more PDUs or PDU sets received in an earlier time window for determining the latency or jitter. The timing information may then be used for determining the expected QoS (e.g., expected RTT) for upcoming/new PDUs or PDU sets in the next time window.

In an example, the timing information may be determined/indicated as a deadline/latency bound and/or survival time that may be satisfied on a per-PDU, per-PDU set or per-QoS flow basis. Such timing information may be determined across one or more associated/correlated QoS flows, including the correlated UL flows, correlated DL flows and correlated UL+DL flows, for example. In another example, the timing information may also be determined/indicated on a count basis (e.g., PDU or PDU set count). The WTRU may trigger an action (e.g., determining mapping and/or forwarding configuration), described in the solutions families herein, when determining the timing information and its impact on whether the expected QoS (e.g., RTT) may or may not be met.

In another example, the WTRU may send the information on the expected QoS, based on the measurements associated with the time duration the PDUs or PDU sets spend in the forwarding configuration (e.g., elapsed time from reception of PDUs or PDUs from higher layers to transmission in UL, elapsed time from transmission of PDUs or PDUs in the UL to reception in the DL, elapsed time from reception of PDUs or PDUs in the DL to forwarding to higher layers)

In another example, the WTRU may send an indication/information on the RTT latency for the PDUs or PDU sets transmitted in the UL and received in the DL based on monitoring/measurement at the AS-layer entities/sublayers (e.g., SDAP, PDCP, RLC, MAC). For example, the PDCP entity used by WTRU for UL transmission of a PDU set (e.g., one or more PDUs) may start a timer (e.g., discard timer, RTT timer), possibly before/after including a sequence number and/or sending the PDU set to lower layer. The WTRU may measure the RTT latency at the PDCP entity based on reception of an associated PDU set (e.g., one or more PDUs) with a corresponding sequence number (e.g., DL sequence number may be added by gNB). In this case, if the timer expires (e.g., discard timer) before receiving the PDU set in the DL, the WTRU may send an indication to gNB to discard/drop the PDU set, send the PDU set with lower priority or send the PDU set with higher priority. In another example, the WTRU may send information/indications/reports to the network (described in another section of the invention) periodically or based on a setting/expiry of a configured timer

Such triggering events and/or conditions may be based on measurements on Uu links. For example, the WTRU may perform measurements over the Uu link (e.g., corresponding to RSRP, RSSI, CQI and CSI), for determining the expected QoS. The channel and/or load measurements made over a certain configured time duration may indicate whether the PDUs or PDU set may be able to achieve the expected QoS during transmission and/or reception, or may exceeded the QoS budget (e.g., RTT latency). The WTRU may trigger an action (e.g., determining mapping configuration), described in the solutions families herein, based on the measurements on a Uu link.

In another example, a WTRU may determine the Uu link conditions based on the number of ARQ/HARQ (ACK/NACK) feedback messages and/or ARQ/HARQ retransmissions made over the one or more HARQ processes associated with the forwarding configurations applied for sending the PDUs or PDU sets. The expected QoS (e.g., RTT latency) may then be determined based on a (configured) mapping function between the feedback/ReTx count in the UL and/or the DL and expected QoS. For example, a ReTx count above a threshold may translate to poor Uu link/channel conditions, and hence, reduced expected QoS. In another example, the WTRU may determine the channel/link conditions based on CSI reports transmitted to and/or received from the network.

For example, the WTRU may be triggered to perform WTRU action(s) and/or send an indication to the network when channel measurements made (e.g., RSRP, RSSI, RSRQ, CQI, CSI) on Uu link increases/decreases with respect to a configured threshold and/or remains above/below a threshold for a certain time duration. For example, the WTRU may be triggered to perform WTRU action(s) when one or more QoS related measurements (e.g., latency/RTT measured for PDUs or PDU sets in one or more forwarding configurations) exceeds a certain threshold.

In another example, the WTRU may trigger an action, described in the embodiments herein, based on determination of the time duration/jitter or change in the time duration/jitter between reception of consecutive PDUs associated with an PDU set, and/or reception of PDUs or PDU sets in one or more correlated flows in UL and/or DL. For example, the WTRU may infer an increase/decrease in the jitter between consecutive PDUs for determining whether the processing load at application/higher layer is high and/or low. In this case, for determining the time duration, the WTRU may set a timer when a first PDU arrives and reset the timer when a second PDU associated with the same PDU set arrives.

Such triggering events and/or conditions may be based on compensation based on expected QoS. For example, the WTRU may be triggered to perform WTRU action(s) based on determination of expected QoS (e.g., RTT) for one or more PDUs or PDU sets, where the expected QoS may indicate that the PDUs may be either delayed or arrive early, during UL transmission and/or DL reception. In this case, the WTRU may trigger an action such that the delayed or early PDUs or PDU sets may be transmitted with a determined compensation amount, for example, by selecting suitable resource configurations (e.g., CG or DG resources). In an example, the action(s) may be triggered when detecting a change (e.g., higher/lower) in the expected QoS (e.g., RTT) for the PDUs or PDU sets by a certain threshold.

In an example, the WTRU may determine the delayed PDU to be sent using a forwarding and/or resource configuration that enables satisfying a compensation amount, where the compensation amount may be determined by subtracting the expected RTT latency from actual RTT latency.

Such triggering events and/or conditions may be based on property associated with the link/channel to which a forwarding configuration is associated. For example, a WTRU may be configured with a property specific to the forwarding configuration/link/channel such as a forwarding configuration/link/channel priority and/or a configuration parameter enabling/disabling the specific action for the forwarding configuration/link/channel.

Such triggering events and/or conditions may be based on a detection of QoS events (e.g., surge in payload size and/or high importance data). For example, QoS events may include surge events associated with an increase in the number of PDUs or PDU sets or data volume, possibly over a time window, indicated/marked with high importance/priority, for example. Similarly, other QoS event may include QoS deflation that my associated with a decrease in the number of PDUs or PDU sets or data/payload volume over a time window. In another example, a QoS event may be when the WTRU detects poor radio conditions. For example, poor radio conditions may be detected based on measurements, increased retransmissions, and/or increased NACKs of uplink packets.

For example, the WTRU may be triggered to perform one or more WTRU actions when detecting one or more QoS events. For example, the WTRU may consider the indicated and/or determined duration the QoS events that are expected to persist. The WTRU may then perform other WTRU actions that may result in falling back to the default configurations, possibly after the end of the detected QoS events,. In an example, when a surge event (e.g., increase in total payload and/or number of PDU sets) is detected, the WTRU may trigger an action to change the resource configuration in UL and/or DL (e.g., CG and/or SPS updated for the duration of the surge) such that the surge may be accommodated within the RTT. When determining reduction in the surge or end of surge event, the WTRU may fallback to using the default resource configuration in UL and/or DL (e.g., default CG and/or SPS).

A WTRU may determines the association of PDUs to PDU sets based on an explicit or implicit indications and/or parameters. For example, the WTRU may determine whether the PDUs in one or more QoS/data flows transmitted in an UL and/or received in a DL are associated with a PDU set and/or an application/high layer function (e.g., NAS). The WTRU may determine the association of the PDUs to PDU sets and/or application/higher layer function based on explicit indication and/or implicit parameters/identifiers detectable by WTRU in the PDUs or QoS flows. Similarly, the WTRU may also determine the association between one or more PDUs or PDU sets transmitted in an UL and one or more PDUs or PDU sets received in a DL based on explicit indication and/or implicit parameters/identifiers detectable by WTRU in the PDUs or PDU sets or QoS flows.

The parameters/identifiers for determining the association of PDUs to PDU sets, or association between UL and DL PDUs or PDU sets may be configured in the WTRU (e.g., via RRC signaling, NAS-layer signaling and/or application/higher layer signaling). The parameters/identifiers used by WTRU for identifying the association of PDUs or PDU sets may include a combination of one or more of the following:

The parameters and/or identifiers used by WTRU for identifying the association of PDUs or PDU sets may include identifiers, IDs, indexes, and/or sequence numbers associated with flows and/or application. For example, the WTRU may determine a first PDU and/or a second PDU in a same QoS flow or different QoS flows may be associated with an PDU set, when detecting common identifiers, IDs, indexes, and/or sequence numbers associated with the PDU set. Such ID may be detected within the PDUs (e.g., in header and/or payload) in one or more QoS flows. For example, the ID of the PDU set and/or application associated with the PDU set may be preconfigured in the WTRU. Similar set of identifiers, IDs, indexes, and/or sequence numbers may be used for identifying the association between PDUs or PDU sets transmitted in UL and PDUs or PDU sets received in a DL.

The parameters and/or identifiers used by WTRU for identifying the association of PDUs or PDU sets may include priority and/or importance information associated with flows. For example, the WTRU may determine a first PDU and/or a second PDU in one or more QoS flows may be associated with a PDU set, based on detection of common and/or similar importance and/or priority indications in the PDUs (e.g., in header and/or payload) in the QoS flows. Such importance/priority indications may be related to spatial or temporal indications. In another example, the WTRU may determine the PDUs may be associated with a PDU set when the importance/priority indications detected by WTRU (e.g., in PDU header or payload) may be above/below one or more importance/priority threshold values. Similar importance/priority indications may be used for identifying the association between PDUs or PDU sets transmitted in an UL and PDUs or PDU sets received in a DL.

The parameters and/or identifiers used by the WTRU for identifying the association of PDUs or PDU sets may include temporal and/or timing information in associated flows. For example, the WTRU may determine that a first PDU and/or a second PDU in one or more QoS flows may be associated with an PDU set when the PDUs may be received by the WTRU within a time duration and/or window. The time duration and/or window may correspond to the time difference between the reception time of a first PDU (e.g., at t1) and a second PDU (e.g., at t2) within the same QoS flow. The time duration/window may correspond to the time difference between the reception time of a PDU in first QoS flow (e.g., at t1) and the reception time of a PDU in second flow (e.g., at t2). In this case, the WTRU may determine that the first and second PDUs in the same or different QoS flows may be associated with a PDU set when the time difference (e.g., t2-t1) is less than a time duration and/or window threshold value. For example, the time duration and/or window threshold value may be associated with the frame-rate used by the application/higher layer (e.g., 60 Hz, 120 Hz) for generating the PDUs or PDU sets.

A similar approach as described above, may be applied for determining the association between PDUs or PDU sets transmitted in an UL and received in a DL based on the temporal and/or timing information. For example, the time duration and/or window may be related to the RTT latency, corresponding to the time difference between the transmission time of a PDU in first flow in UL (e.g., at t1) and the reception time of a PDU in second flow in DL (e.g., at t2). In this case, the WTRU may determine that the first and second PDUs in the UL and DL flows may be associated when the time difference (e.g., t2-t1) is less than a time duration/window threshold value (e.g., RTT latency threshold).

In another example, the WTRU may determine that the first and second PDUs in one or more flows may be associated with an PDU set, or may be associated between UL and DL, based on a common format and/or granularity of the timing information (e.g., timestamps, packet count, sequence numbers) carried in the PDUs.

The parameters and/or identifiers used by WTRU for identifying the association of PDUs or PDU sets may include Spatial/pose information in associated flows. For example, the WTRU may determine a first PDU and/or a second PDU in one or more QoS flows may be associated with a PDU set, or may be associated between an UL and a DL, when the PDUs carrying the spatial information correspond to common spatial parameters/IDs. The spatial parameters/IDs, for example, may include any of the following: direction/orientation of FoV of the user/WTRU, slice and/or tile of the video/media frame, location information (e.g., coordinates of the WTRU), pose information, etc. The spatial parameters and/or IDs may be determined by WTRU based on detection of certain PDUs carrying spatial information (e.g., pose and/or control PDU which may be identified by WTRU based on data type identifiers) or detection of other PDUs which may contain spatial information within the PDUs (e.g., in header and/or payload).

The parameters and/or identifiers used by a WTRU for identifying the association of PDUs or PDU sets may include an explicit indication from application/higher layers/AS-layers. For example, the WTRU may determine that a first PDU and/or a second PDU in one or more QoS flows may be associated with a PDU set, or may be associated between UL and DL, when receiving an explicit indication/message from higher- layers/AS-layers in WTRU or network. For example, the WTRU may receive, in the indication, the timing information (e.g., periodicity, burst time window and/or duration) during which the PDUs may be associated. In this case, outside of the timing information (e.g., burst duration), the WTRU may assume that the PDUs may be uncorrelated and/or not associated with a PDU set, or between an UL and a DL.

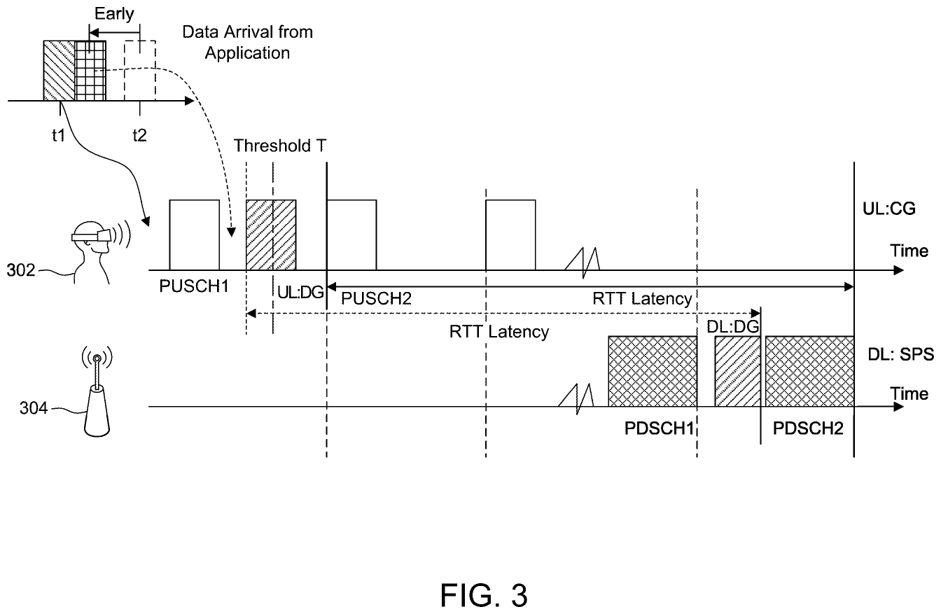

A WTRU may determine the alignment between an UL and a DL resource configurations for meeting RTT latency. FIG. 3 is a diagram illustrating an example procedure of a WTRU determining the alignment between an UL resource configuration and a DL resource configuration for meeting RTT latency.

A shown in FIG. 3, the WTRU 302 may determine the alignment between an UL resource configuration and a DL resource configuration for meeting RTT latency based on the timing of PDU or PDU set arrival and a configured threshold associated with RTT latency. For ensuring RTT latency, the WTRU 302 may be configured, by the network 304 (e.g., gNB), with CG and/or SPS resource configurations for performing UL transmissions and/or DL receptions of PDUs or PDU sets. However, for meeting tight RTT latency (e.g., 15 ms) configuring high periodicity for CG and SPS resources can be wasteful when the arrival time of PDUs or PDU sets from high layers at WTRU is not known in advance. This may be due to jitter and/or processing delays at the higher layers or application layers.

Additionally, the base station may not know which SPS occasion may correspond to or associated with the CG occasion that carries the associated UL and DL PDUs or PDU sets within the RTT latency. Since such association information may be visible to the WTRU, the WTRU may assist the base station to properly align the CG and SPS resource configurations and/or parameters (e.g., start offset, periodicity, duration, number of PUSCH/PDSCH slots) based on arrival time of the PDUs or PDU sets for meeting the RTT latency.

For enabling such an approach, the WTRU may receive configuration information from the network, including one or more CG configurations and/or resources, one or more SPS configurations and/or resources and a threshold T associated with ensuring the RTT latency. The threshold T may be indicated in units of milliseconds, time slots, PUSCH slots. The CG and/or SPS configurations and/or resources received by WTRU may correspond to the default configurations, which the WTRU may be expected to use during default and/or normal conditions (e.g., UL data arrives within threshold T). For example, the configuration information may be received by the WTRU via RRC signaling, MAC CE, DCI. The configuration may be received based on the assistance information provided by WTRU to the network, indicating traffic pattern and QoS information, including the expected RTT latency to be met during UL transmissions and DL receptions, number of associated flows in UL and/or DL, delay bound in UL and/or DL (e.g., PSDB), expected periodicity of data transmissions in UL and/or DL, and/or payload sizes (e.g., mean, max, min) of PDUs or PDU sets in an UL and/or a DL.

The WTRU may then receive from, higher layers or application layers, the data consisting of one or more PDUs or PDUs sets expected to be transmitted in an UL using the CG resources. If the UL PDUs or PDU sets are received or expected to be received within T time slots before the next CG occasion (e.g., where a CG occasion may consist of one or more CG resources or PUSCH slots), the WTRU may transmit the one or more UL PDUs or PDU sets using the CG resources in the next CG occasion. The WTRU may then receive, in the DL, the one or more DL PDUs or PDU sets which may be associated with the UL PDUs or PDU sets within the RTT latency. The DL PDUs or PDU sets may be received in SPS resources in one or more SPS occasions or PDSCH slots,. Such CG and SPS resources may correspond to the default CG and/or SPS configured preconfigured in the WTRU. Alternatively, the DL PDUs or PDU sets may be received by the WTRU via dynamic grant/scheduling resources/slots.

Upon transmitting the UL PDUs or PDU sets using CG resources, the WTRU may go into a sleep mode. Such transitioning to sleep mode may be done by WTRU when the WTRU is not expecting to transmit and/or receive any data in an UL/DL for the duration of RTT latency or any other duration. In an example, the WTRU may also send an indication to the base station indicating the transition to sleep mode. During sleep mode, the WTRU may not monitor for any DL control channel/indication (e.g., DCI, PDCCH, wake-up signal) until the expected reception time window of the DL PDUs or PDU sets using SPS resources. The time window for the WTRU to initiate monitoring for DL control channel/indication and/or DL data reception (e.g., PDSCH) may be related to the RTT latency. For example, after transmitting the UL data at t1, the WTRU may go into sleep mode for a duration of RTT latency R. The WTRU may then initiate monitoring for DL control/data reception at t1+R−d ms/slots, where d may correspond to a start offset time which may range from 0 ms/slots to a few ms/slots.

If the UL PDUs or PDU sets are received or expected to be received earlier than T time slots before the next CG occasion, the WTRU may determine whether any of the DL time slots/occasions associated with the one or more configured SPS configurations and/or resources may allow to receive the DL PDUs or PDUs sets, associated with the UL PDUs or PDU sets, within the RTT latency. The WTRU may determine the DL time slots/occasions and possibly the number of PDSCH slots based on the preconfigured SPS configurations/resources and the awareness of the DL PDUs or PDU sets (e.g., payload sizes, timing of arrival) expected for the PDUs or PDU sets transmitted in the UL.

If one or more time slots/occasions associated with the one or more configured SPS configurations/resources do not match with the DL time slots/occasions determined by the WTRU (e.g., no matching time slots within RTT latency), the WTRU may transmit an indication to the base station to request for a first DG resource for an UL transmission and/or a second DG resource for a DL reception in one or more time slots before/within the RTT latency. Such an indication may be transmitted by WTRU in an SR (e.g., UCI), BSR (e.g., MAC CE) or RRC message, for example. Such an indication may contain information on the expected RTT, remaining time for transmission in an UL and/or reception in the DL, expected payload size of PDUs or PDU sets in UL/DL, priority of data transmitted in an UL and expected in a DL, indication of not finding suitable resources/time slots for DL reception, indication to update/modify the CG and/or SPS resources/configuration (e.g., change start offset, change periodicity, increase/decrease the CG and/or SPS grant size, change parameters such as MCS, change the validity duration for any modification to the CG/SPS to be applicable, etc.)

In an example, the WTRU may receive the resource allocation for DG, including for the first DG resource (e.g., for UL transmission of PDUs or PDU sets that arrive early) and/or the second DG resource (e.g., for DL reception of associated PDUs or PDU sets). In another example, the WTRU may receive an indication indicating the adjustment/modification of CG and/or SPS configurations/resources and/or the activation/deactivation indication of new CG and/or SPS configurations/resources. Such adjusted/new CG and/or SPS resources may be used to accommodate the early arrival of the PDUs or PDU sets, for example. The WTRU may also receive information on the duration for which the adjustment/modification of CG and/or SPS resources may apply, after which the WTRU may transition/fallback to using the default CG and/or SPS resources. Such resource allocation indications (e.g., for DG, CG, SPS) may be received by WTRU in DCI (e.g., single DCI containing resource allocation for UL and DL, or multiple DCIs for UL and DL resource allocation), MAC CE or RRC message.

The WTRU may then transmit the one or more early UL PDUs or PDU sets using the first DG resources and/or adjusted/new CG resources, for example. The WTRU may receive in DL the one or more DL PDUs or PDU sets which may be associated with the UL PDUs or PDU sets within the RTT latency, using the second DG resources and/or adjusted/new SPS resources.

Alternatively, if one or more time slots and/or occasions associated with the one or more configured SPS configurations and/or resources match with the DL time slots and/or occasions determined by the WTRU (e.g., no matching time slots within RTT latency), the WTRU may transmit an indication to base station to request for DG resources for UL transmission. Such an indication may be transmitted by the WTRU in an SR (e.g., UCI), BSR (e.g., MAC CE) or RRC message. The other may also send other information to base station, similar to the case when the WTRU is unable to find any matching DL time slots/occasions for DL reception. In an example, the WTRU may receive the resource allocation for the DG resources for UL transmission of PDUs or PDU sets that arrive early. In another example, the WTRU may receive an indication indicating the adjustment/modification of CG the configuration/resource and/or the activation/deactivation indication of a new CG configuration/resource. The WTRU may also receive information on the duration for which the adjustment and/or modification of CG resources may apply, after which the WTRU may transition and/or fallback to using the default CG resources. Such resource allocation indications (e.g., for DG, CG, SPS) may be received by the WTRU in DCI (e.g., single DCI containing resource allocation for UL and DL, or multiple DCIs for UL and DL resource allocation), MAC CE, or RRC message.

The WTRU may then transmit the one or more early UL PDUs or PDU sets using the received DG resources and/or adjusted/new CG resources. The WTRU may receive in DL the one or more DL PDUs or PDU sets which may be associated with the UL PDUs or PDU sets within the RTT latency, using the default SPS resources.

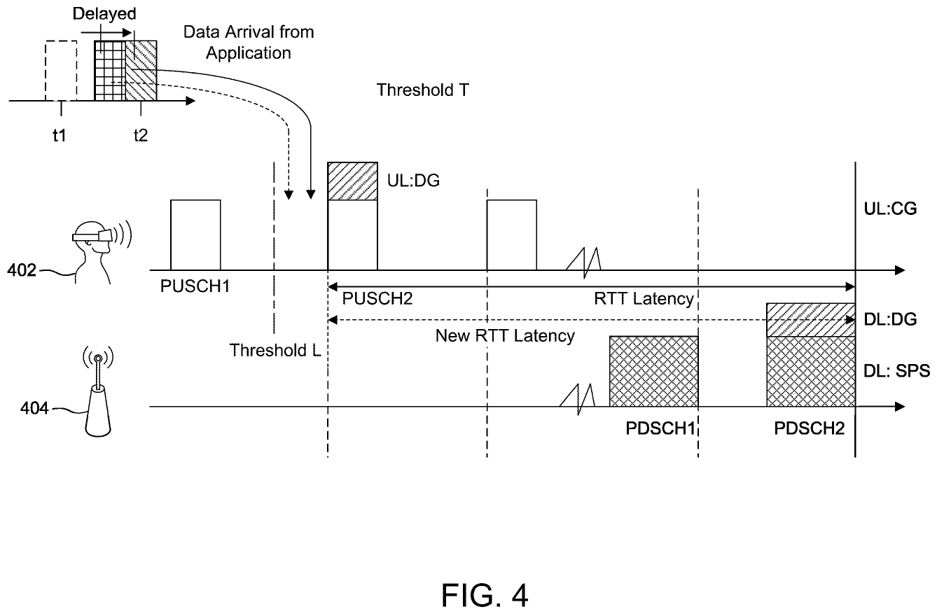

A WTRU may determine the timing for adjusted DL reception within RTT latency based on delays in UL transmission. FIG. 4 is a diagram illustrating an example of a WTRU determining the timing for DL reception to compensate for higher than expected delay during PDU arrival for UL transmission.

As shown in FIG. 4, in one embodiment, a WTRU may determine the timing for a DL reception to compensate for higher than expected delay during an UL transmission to meet an adjusted and/or new RTT latency. In an example scenario, higher than expected processing delays at the application and/or higher layers (e.g., video codec) at the WTRU may cause an earlier UL data to arrive much later than its intended CG occasion and closer to the next CG occasion. However, the CG grant in the next CG occasion may not be enough to accommodate the earlier (e.g., delayed PDU and/or PDU sets) and new UL data. This may impact the UL transmission and the DL reception of the delayed data within the RTT latency.

Because the WTRU may have visibility of the delays during data transmission in UL, the WTRU may determine some adjustments that may be performed to the timing and/or the grant sizes of the UL and/or the DL resource configurations such that the RTT latency may be maintained. For enabling such an approach, the WTRU may receive configuration information from network, including one or more CG configurations and/or resources, one or more SPS configurations and/or resources and a threshold L associated with ensuring the RTT latency with consideration for jitter. The threshold L may correspond to an upper bound in terms of how much a set of one or more earlier PDUs or PDU sets (e.g., PDUs or PDU sets that may be mapped to an earlier CG occasion) may be delayed due to jitter for meeting the RTT latency with certain adjustments to the UL and/or DL resources.

The threshold L may be indicated in the units of milliseconds, time slots, PUSCH slots, etc. The CG and/or SPS configurations/resources received by WTRU may correspond to the default configurations, which the WTRU may be expected to use during default/normal conditions (e.g., UL data arrives within and/or earlier than threshold L). Such configuration information may be received by WTRU via RRC signaling, MAC CE, DCI, for example. Such configuration may be received based on the assistance information provided by WTRU to the network, indicating traffic pattern and QoS information, including the expected/default RTT latency to be met during UL transmissions and DL receptions, maximum jitter at WTRU during UL transmission, payload sizes (e.g., mean, max, min) of PDUs or PDU sets in UL and/or DL, etc.

The WTRU may receive from application/higher layers a first UL data (e.g., consisting of one or more PDUs or PDU set delayed due to jitter) and a second UL data (e.g., consisting of one or more PDUs or PDU sets). In this case, the first UL data may be associated with and/or intended to use a previous CG occasion, and the second UL data may be associated with and/or intended to use the current CG occasion during UL transmission.

If the first UL data is received or expected to be received within L time slots before the next CG occasion (e.g., where a CG occasion may consist of one or more CG resources or PUSCH slots), and/or the CG resource in the next CG occasion is able to accommodate the first and second UL data, the WTRU may transmit the first and second UL data using the CG resources in the next CG occasion. On the other hand, if the CG resource in the next CG occasion is unable to accommodate the first and second UL data, the WTRU may determine a new RTT latency for the receiving DL data associated with the delayed first UL data based on timing of next CG occasion and expected RTT latency. For example, the WTRU may determine the new RTT latency by subtracting the start time of the next CG occasion from the expected RTT latency.

The WTRU may determine the one or more DL time slots/occasions and/or possibly the number of PDSCH slots based on the new RTT latency for possible reception of DL data (e.g., one or more PDUs or PDU sets) associated with the first UL data within the new RTT latency.

The WTRU may transmit an indication to the base station to request for a first DG resource for UL transmission at a same/similar time slot/occasion as the next CG occasion and/or a second DG resource for DL reception in one or more time slots before/within the new RTT latency. Such an indication may be transmitted by the WTRU in an SR (e.g., UCI), BSR (e.g., MAC CE) or RRC message. Such an indication may contain information on the new RTT, remaining time for transmission in UL and/or reception in DL, expected payload size of PDUs or PDU sets in UL/DL, priority of data transmitted in UL and expected in DL, indication to update/modify the CG and/or SPS resources/configuration (e.g., change start offset, change periodicity, increase/decrease the CG and/or SPS grants size per slot, change parameters such as MCS, change the validity duration for any modification to the CG/SPS to be applicable), etc.

In an example, the WTRU may receive the resource allocation for DG, including for the first DG resource (e.g., for UL transmission of delayed PDUs or PDU sets) and/or the second DG resource (e.g., for DL reception of associated PDUs or PDU sets). In another example, the WTRU may receive an indication indicating the adjustment and/or modification of CG and/or SPS configurations/resources and/or the activation/deactivation indication of new CG and/or SPS configurations/resources. Such adjusted/new CG and/or SPS resources may be used to accommodate the delayed PDUs or PDU sets, for example. The WTRU may also receive information on the duration for which the adjustment/modification of CG and/or SPS resources may apply, after which the WTRU may transition/fallback to using the default CG and/or SPS resources, for example. Such resource allocation indications (e.g., for DG, CG, SPS) may be received by WTRU in DCI (e.g., single DCI containing resource allocation for UL and DL, or multiple DCIs for UL and DL resource allocation), MAC CE or RRC message.

The WTRU may then transmit the one or more delayed first UL data (e.g., one or more PDUs or PDU sets) using the first DG resources and/or adjusted/new CG resources, for example. The WTRU may receive in DL the DL data (e.g., one or more PDUs or PDU sets) which may be associated with the first UL data within the new RTT latency, using the second DG resources and/or adjusted/new SPS resources, for example. The WTRU may transmit the second UL data using the default CG resource in the next CG occasion. The WTRU may receive the DL data, which may be associated with the second UL data, using the default SPS resource/occasions within the expected/default RTT.

A WTRU may determine adjustments to the timing of the DL data reception based on changes to RTT latency. In one embodiment, the WTRU may determine a new RTT latency based on QoE and/or application layer measurement (e.g., estimation/measurement of remaining time of data in application buffer) and may send an indication to gNB to adjust the UL and DL resource configurations to match with the new RTT latency. For example, an application that is hosted in the TE part of the WTRU may send this QoE and/or application layer measurement to the MT part of the WTRU in an AT command.

In an example scenario, the RTT latency for some PDUs or PDU sets transmitted in UL and received in DL may vary over time based on some application layer functionalities (e.g., amount of pose changes, application layer corrections, error concealment at application) and/or QoE measurements. For example, if the WTRU pose changes are significant (e.g., amount of pose change or movement of WTRU is above a threshold), the latency for DL may be lower, even when the actual latency in the UL is within an UL PDB value. In this scenario, the RTT latency may be most stringent (e.g., RTT latency may be set to 15 ms). Alternatively, if the WTRU pose changes are not significant, and/or the application may perform some corrections for any pose changes with existing data, the DL latency may be relaxed. In this scenario, the RTT latency may be relaxed (e.g., RTT latency may be set to 50 ms). In this regard, performing some adjustments/changes to the UL and/or DL resource configurations (e.g., CG, SPS, DG) based on changes to expected RTT latency may be beneficial from scheduling, resource usage efficiency and power saving perspective.

For enabling such approach, the WTRU may receive configuration information from network, including one or more CG configurations and/or resources, one or more SPS configurations/resources and a threshold D associated RTT difference with respect to a default RTT latency value. The WTRU may be configured with the CG and/or SPS configurations/resources for meeting the default RTT latency value.

The WTRU may receive from application/higher layers UL data (e.g., consisting of one or more PDUs or PDU set) which may be expected to be transmitted in UL. The WTRU may also receive from application/higher layer, the data consumption status, including the current application buffer level and/or the data consumption rate. Such data consumption status may be related to the data that have been previously received by WTRU in DL and/or waiting in application layer buffers to be processed and/or consumed later. Next, the WTRU may determine the new RTT latency that is expected for the UL data and/or the associated DL data. For example, the new RTT latency may be determined based on estimation of the remaining time for depleting data in application buffer, and data consumption status (e.g., remaining time=current buffer level/data consumption rate). For example, an application that is hosted in the TE part of the WTRU may send this data consumption status to the MT part of the WTRU in an AT command.

If the difference between the new RTT latency and default RTT latency is less than or equal to the RTT difference threshold value D (e.g., |default RTT−new RTT>D), indicating small difference compared to default RTT latency, the WTRU may transmit the UL data using the CG resource in the next CG occasion. The WTRU may then receive the DL data, associated with the transmitted UL data, in SPS resources in one or more SPS occasions before the default RTT latency.

If the difference between the default RTT latency and new RTT latency is greater than the RTT difference threshold value D (e.g., default RTT−new RTT>D), indicating a more stringent new RTT latency compared to default RTT latency, the WTRU may determine a new DL time slot/occasion for receiving the DL data associated with the UL data, for DL reception within the new RTT latency. The WTRU may transmit an indication to gNB (e.g., in SR, UCI, BSR, MAC CE or RRC message), indicating any of the following: new RTT latency, the determined new DL time slot/occasion for receiving the DL data, request for DG resources for DL reception, and request for SPS resources for DL reception. The WTRU may transmit the UL data using DG resource or CG resource in the next CG occasion. The WTRU may receive from gNB the DG resources (e.g., in DCI) and/or SPS resources for DL data reception. The WTRU may then receive the DL data in the DG and/or SPS resources before or at the new RTT latency.

If the difference between the new RTT latency and default RTT latency is greater than the RTT difference threshold value D (e.g., new RTT−default RTT>D), indicating a relaxed new RTT latency compared to default RTT latency, the WTRU may determine a new DL time slot/occasion for receiving the DL data associated with the UL data, for DL reception within the new relaxed RTT latency. The WTRU may transmit an indication to gNB (e.g., in SR, UCI, BSR, MAC CE or RRC message), indicating any of the following: new RTT latency, the determined new DL time slot/occasion for receiving the DL data, and request to skip one or more SPS resources for DL reception associated with the default RTT latency. The WTRU may transmit the UL data using DG resource or CG resource in the next CG occasion. The WTRU may receive from gNB the DG resources (e.g., in DCI), new SPS resources associated with new RTT latency and/or an indication for acknowledging the skipping of SPS resources associated with default RTT latency. The WTRU may then receive the DL data in the DG and/or SPS resources before or at the new relaxed RTT latency.

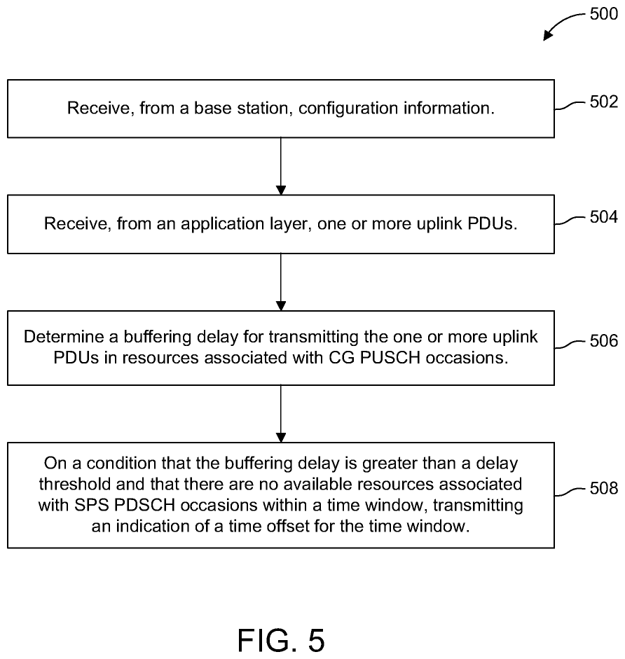

FIG. 5 illustrates an exemplary method performed by a WTRU. At 502, the WTRU may receive, from a base station, configuration information. At 504, the WTRU may receive, from an application layer, one or more protocol data units (PDUs) associated with at least one of an uplink PDU set. At 506, the WTRU may determine a buffering delay for transmitting the PDUs in resources associated with configured grant (CG) physical uplink shared channel (PUSCH) transmission occasions. At 508, the WTRU, on a condition that the buffering delay is greater than a delay threshold and that there are no available resources associated with semi-persistent scheduling (SPS) physical downlink shared channel (PDSCH) transmission occasions within a time window, transmitting an indication of a time offset for the time window.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1. A method performed by a wireless transmit/receive unit (WTRU), the method comprising:
receiving, from a base station, configuration information;
receiving, from an application layer, one or more uplink protocol data units (PDUs);
determining a delay for transmitting the one or more uplink PDUs in resources associated with configured grant (CG) physical uplink shared channel (PUSCH) occasions;
determining that the delay is greater than a delay threshold; and
based on the determination that the delay is greater than a delay threshold, transmitting an indication of a time offset for a time window.

2. The method of claim 1, wherein the configuration information includes at least one of a time offset associated with a start of the time window.

3. The method of claim 1, wherein the configuration information includes the delay threshold.

4. The method of claim 1, wherein the configuration information includes one or more start offsets associated with the time window.

5. The method of claim 1, wherein the configuration information includes a CG configuration and a SPS configuration.

6. The method of claim 5, wherein a CG PUSCH occasion in the CG configuration is time-aligned in the time window.

7. The method of claim 5, wherein a SPS PDSCH occasion in the SPS configuration is time-aligned in the time window.

8. (canceled)

9. The method of claim 1, wherein the indication is transmitted in an uplink control information (UCI).

10. The method of claim 1, further comprising:
transmitting, to the base station, in a CG PUSCH occasion, the one or more uplink PDUs.

11. A wireless transmit/receive unit (WTRU) comprising:
a transceiver; and
a processor;
wherein, the transceiver and process are configured to:
receive, from a base station, configuration information;
receive, from an application layer, one or more uplink protocol data units (PDUs);
determine a delay for transmitting the one or more uplink PDUs in resources associated with configured grant (CG) physical uplink shared channel (PUSCH) occasions; and
on a condition that the delay is greater than a delay threshold, transmit an indication of a time offset for a time window.

12. The WTRU of claim 11, wherein the configuration information includes at least one of a time offset associated with the time window.

13. The WTRU of claim 11, wherein the configuration information includes the delay threshold.

14. The WTRU of claim 11, wherein the configuration information includes one or more start offsets associated with the time window.

15. The WTRU of claim 11, wherein the configuration information includes a CG configuration and a SPS configuration.

16. The WTRU of claim 15, wherein a CG PUSCH occasion in the CG configuration is time-aligned in the time window.

17. The WTRU of claim 15, wherein a SPS PDSCH occasion in the SPS configuration is time-aligned in the time window.

18. (canceled)

19. The WTRU of claim 11, wherein the indication is transmitted in an uplink control information (UCI).

20. The WTRU of claim 11, wherein the transceiver and processor are further configured to:
transmit, to the base station, in a CG PUSCH occasion, the one or more uplink PDUs.

21. The method of claim 1, further comprising:
determining that there are no available resources associated with semi-persistent scheduling (SPS) physical downlink shared channel (PDSCH) occasions within the time window.

22. The WTRU of claim 11, wherein the transceiver and processor are further configured to:
determine that there are no available resources associated with semi-persistent scheduling (SPS) physical downlink shared channel (PDSCH) occasions within the time window.
